(19) United States
(12) Patent Application Publication
(10) Pub. No.: US 2022/0395113 A1
(43) Pub. Date: Dec. 15, 2022

(54) PICTURE FRAME WITH BUILT-IN SPEAKERS

(71) Applicant: AFH Industries Inc., New York, NY (US)

(72) Inventor: Isaac Saideh, Brooklyn, NY (US)

(21) Appl. No.: 17/841,163

(22) Filed: Jun. 15, 2022

Related U.S. Application Data
(60) Provisional application No. 63/237,405, filed on Aug. 26, 2021.
(60) Provisional application No. 63/226,491, filed on Jul. 28, 2021.
(60) Provisional application No. 63/202,522, filed on Jun. 15, 2021.

(51) Int. Cl. A47G 1/06; H04R 1/02; H02J 50/12; H02J 7/00; H02J 50/05

(52) U.S. Cl. CPC A47G 1/06; H04R 1/028; H02J 50/12; H02J 7/0013; H02J 7/0063; H02J 50/05; A47G 2200/143

(57) ABSTRACT

A picture frame including a plurality of frame elements and a speaker system disposed within the plurality of frame elements. The speaker system includes one or more audio speakers disposed within the plurality of frame elements or between the plurality of frame elements, at least one control panel configured for manual control of the one or more audio speakers, and one or more rechargeable batteries configured to power the speaker system. The frame elements are configured to hold a chemical canvas on which artwork is rendered either mounted within the frame elements or over the frame elements.

### RELATED APPLICATION

This application claims priority to and the benefit of U.S. Provisional Patent Application No. 63/202,522, filed Jun. 15, 2021 and entitled PICTURE FRAME WITH BUILT-IN SPEAKERS, U.S. Provisional Patent Application No. 63/226,491, filed Jul. 28, 2021 and entitled PICTURE FRAME WITH BUILT-IN SPEAKERS, and U.S. Provisional Patent Application No. 63/237,405, filed Aug. 26, 2021 and entitled PICTURE FRAME WITH BUILT-IN SPEAKERS, the contents of which are incorporated herein by reference in their entirety.

### FIELD

The present disclosure generally relates to picture frames with canvas for mounting printed photographs or artwork thereon, and having audio speakers that are built into and/or integrated therein.

### BACKGROUND

Conventional picture frames for mounting printed photographs or other artwork on canvas do not contain an audio aspect. While digital photo frames exist, such frames cannot be used to mount printed photographs or other artwork on canvas, and typically do not provide speakers for sound.

A problem exists in that conventional picture frames are not configured for integration with an audio speaker system and are not particularly configured to integrate such systems in a manner that does not detract from the aesthetics of the artwork mounted on or within the picture frame.

What is needed is a frame for mounting printed photographs or other artwork on canvas that also provides for an audio sound system in an aesthetically pleasing manner.

### SUMMARY

An object of the present invention to provide a frame for mounting printed photographs or other artwork on canvas which also provides for audio sound systems.

The present disclosure generally relates to picture frames for canvas having audio speakers that are built into and/or integrated therein.

A picture frame according to an exemplary embodiment of the present invention comprises: a plurality of frame elements configured for mounting therein a chemical canvas on which artwork is rendered; and a speaker system disposed within the plurality of frame elements, the speaker system comprising: two or more speaker components disposed within the plurality of frame elements, each of the two or more speaker components comprising: 1) a housing; 2) an audio speaker disposed within the housing; 3) a control panel disposed within the housing and configured for manual control of the audio speaker; 4) one or more rechargeable batteries disposed within the housing and configured to power the speaker component and configured to be charged using a wireless magnetic resonance charger or a capacitive charger; and 5) a circuit board disposed within the housing that holds electronic components of the speaker component.

A picture frame according to an exemplary embodiment of the present invention comprises: a plurality of frame elements configured for mounting thereon a chemical canvas on which artwork is rendered; and a speaker system disposed within the plurality of frame elements, the speaker system comprising: a speaker component disposed between the plurality of frame elements, the speaker component comprising: 1) a housing; 2) an audio speaker disposed within the housing and exposed at a front portion of the picture frame so as to play audio through the chemical canvas; 3) a control panel disposed within the housing and configured for manual control of the audio speaker, the control panel being exposed at a back portion of the picture frame; 4) one or more rechargeable batteries disposed within the housing and configured to power the speaker component and configured to be charged using a wireless magnetic resonance charger or a capacitive charger; and 5) a circuit board disposed within the housing that holds electronic components of the speaker component.

A picture frame according to an exemplary embodiment of the present invention comprises: a plurality of frame elements; a chemical canvas on which artwork is rendered and which is mounted directly on the plurality of frame elements; and a speaker system disposed within the plurality of frame elements, the speaker system comprising: a speaker component, the speaker component comprising: 1) an audio speaker disposed between the plurality of frame elements or within a first one of the plurality of frame elements; 2) a control panel disposed within the first one of the plurality of frame elements or a second one of the plurality of frame elements that is different from the first one of the plurality of frame elements and configured for manual control of the audio speaker; 3) a battery compartment that houses one or more rechargeable batteries, the battery compartment disposed within the first one of the plurality of frame elements, the second one of the plurality of frame elements or a third one of the plurality of frame elements that is different from the first one of the plurality of frame elements and the second one of the plurality of frame elements, the one or more rechargeable batteries configured to power the speaker component and configured to be charged using a wireless magnetic resonance charger or a capacitive charger; and 4) a circuit board that holds electronic components of the speaker component, the control panel and the battery compartment being exposed through an opening in the chemical canvas.

A picture frame according to an exemplary embodiment of the present invention comprises: a plurality of frame elements; and a speaker system disposed within the plurality of frame elements, the speaker system comprising: one or more audio speakers disposed within the plurality of frame elements or mounted between the plurality of frame elements; at least one control panel configured for manual control of the one or more audio speakers; and one or more rechargeable batteries configured to power the speaker system, wherein the frame elements are configured to hold a chemical canvas on which artwork is rendered either mounted within the frame elements or over the frame elements.

In an exemplary embodiment the electronic components comprise at least one of a receiver, a controller or an amplifier.

In an exemplary embodiment the two or more speaker components are disposed on differing frame elements.

In an exemplary embodiment the picture frame further comprises a wireless communication adapter configured for communication with an external user controller.

In an exemplary embodiment the one or more rechargeable batteries are configured to be charged using an external charging plug.

In an exemplary embodiment the one or more rechargeable batteries are disposed within a removeable battery pack.

In an exemplary embodiment the picture frame further comprises an external battery pack configured to recharge the one or more rechargeable batteries.

In an exemplary embodiment the external battery pack comprises one or more conductive pins, and at least one of the two or more speaker components comprises one or more pin receptacles configured for engagement with the one or more conductive pins to transmit electrical energy to the one or more batteries within the at least one of the two or more speaker components.

In an exemplary embodiment the speaker components are configured for control by a dedicated application program installed on a mobile phone.

### BRIEF DESCRIPTION OF THE DRAWINGS

The above and related objects, features and advantages of the present disclosure will be more fully understood by reference to the following, detailed description of the preferred, albeit illustrative, embodiments of the present invention when taken in conjunction with the accompanying figures, wherein:

FIG. 1A depicts a picture frame for printed photographs on canvas, according to an exemplary embodiment of the present invention;

FIG. 1B depicts a first exploded view of the picture frame according to an exemplary embodiment of the present invention;

FIG. 1C depicts a second exploded view of the picture frame according to an exemplary embodiment of the present invention;

FIG. 1D depicts a third partial exploded view of the picture frame according to an exemplary embodiment of the present invention;

FIG. 1E depicts an interior electrical connection of the picture frame according to an exemplary embodiment of the present invention;

FIG. 2A depicts a rear view of a picture frame for printed photographs on canvas, according to an exemplary embodiment of the present invention;

FIG. 2B depicts a front view of the picture frame according to an exemplary embodiment of the present invention;

FIGS. 2C and 2D depict front views of the picture frame according to an exemplary embodiment, and include a charging device to recharge a battery;

FIG. 2E depicts a first exploded view of the picture frame according to an exemplary embodiment of the present invention;

FIG. 2F depicts a second exploded view of the picture frame according to an exemplary embodiment of the present invention;

FIG. 2G depicts a flow diagram for assembling a picture frame according to an exemplary embodiment of the present invention;

FIG. 2H depicts an exemplary process for mounting a board upon an interior frame element according to an exemplary embodiment of the present invention;

FIG. 2I depicts an exemplary process for mounting and fitting a first interior frame element inside a second interior frame element according to an exemplary embodiment of the present invention;

FIG. 2J depicts an exemplary process for mounting a housing on a board such that the front portion of the housing fits through an opening in the board according to an exemplary embodiment of the present invention;

FIG. 2K shows an exemplary mounting process whereby a board is mounted atop a housing such that a control panel on the rear of the housing is exposed and accessible through an opening of the board according to an exemplary embodiment of the present invention;

FIG. 2L depicts an exemplary process of disposing L-shaped structural members around the edges of boards according to an exemplary embodiment of the present invention;

FIG. 2M depicts the disposal of fastening pegs in the exposed corners around the perimeter of an interior frame element according to an exemplary embodiment of the present invention;

FIG. 2N depicts an exemplary disposal of frame elements over an interior frame element according to an exemplary embodiment of the present invention;

FIG. 3A depicts a picture frame for printed photographs on canvas, according to an exemplary embodiment of the present invention;

FIG. 3B depicts a front view of the picture frame according to an exemplary embodiment of the present invention;

FIG. 3C depicts a first exploded view of the picture frame according to an exemplary embodiment of the present invention;

FIG. 3D depicts a second exploded view of the picture frame according an exemplary embodiment of the present invention;

FIG. 3E depicts a rear view of the picture frame according to an exemplary embodiment of the present invention;

FIGS. 4 and 5 depict additional components that may be included with any of the exemplary embodiments of the present invention;

FIG. 6 depicts a view of components that can be used to externally and wirelessly power the speakers and other electrical components disposed within the picture frame, in accordance with exemplary embodiments of the present invention;

FIG. 7 is a cross-sectional view of components that can be used to wirelessly power a picture frame, in accordance with exemplary embodiments of the present invention;

FIG. 8A depicts a perspective view of a picture frame and includes an exploded view of a wireless charging device to charge rechargeable batteries within the picture frame, in accordance with exemplary embodiments of the present invention;

FIG. 8B depicts an exploded front view of the wireless charging device to charge rechargeable batteries within the picture frame, in accordance with exemplary embodiments of the present invention;

FIG. 8C depicts an exploded side view of the wireless charging device to charge rechargeable batteries within the picture frame, in accordance with exemplary embodiments of the present invention;

FIG. 9A depicts an exploded view of a picture frame configured for charging a wireless device, in accordance with exemplary embodiments of the present invention;

FIG. 9B depicts a first perspective view of the picture frame of FIG. 9A charging a wireless, in accordance with exemplary embodiments of the present invention; and

FIG. 9C depicts a second perspective view of the picture frame of FIG. 9A, in accordance with exemplary embodiments of the present invention.

### DETAILED DESCRIPTION OF THE EXEMPLARY EMBODIMENTS

The present disclosure generally relates to picture frames for canvas having audio speakers that are built into and/or integrated therein.

The figures depict exemplary embodiments of a picture frame for canvas having a built-in audio speaker.

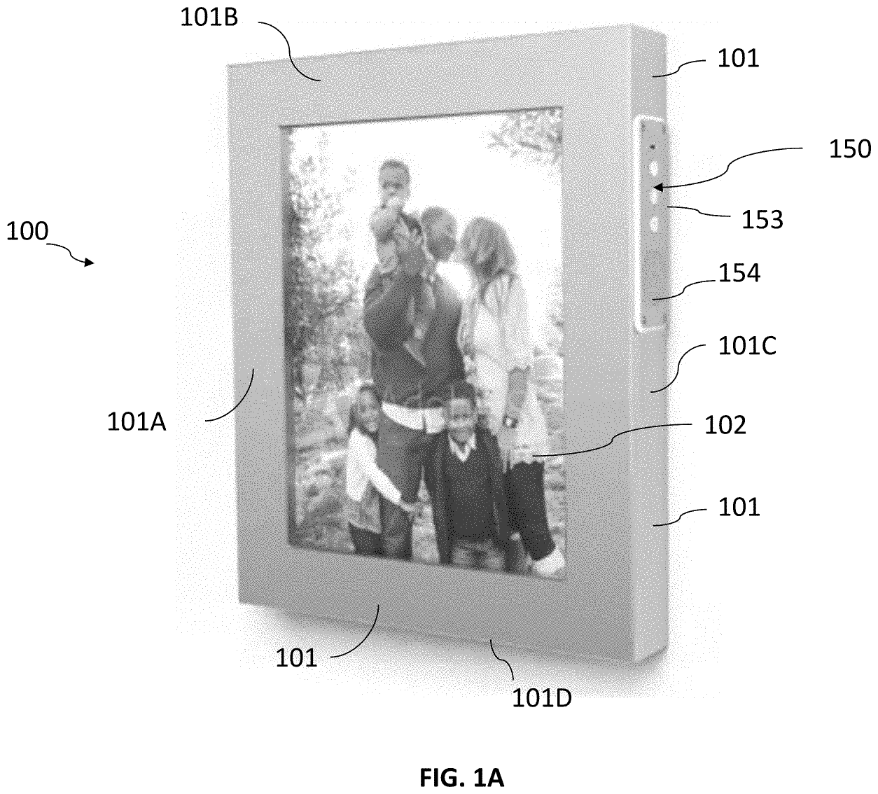

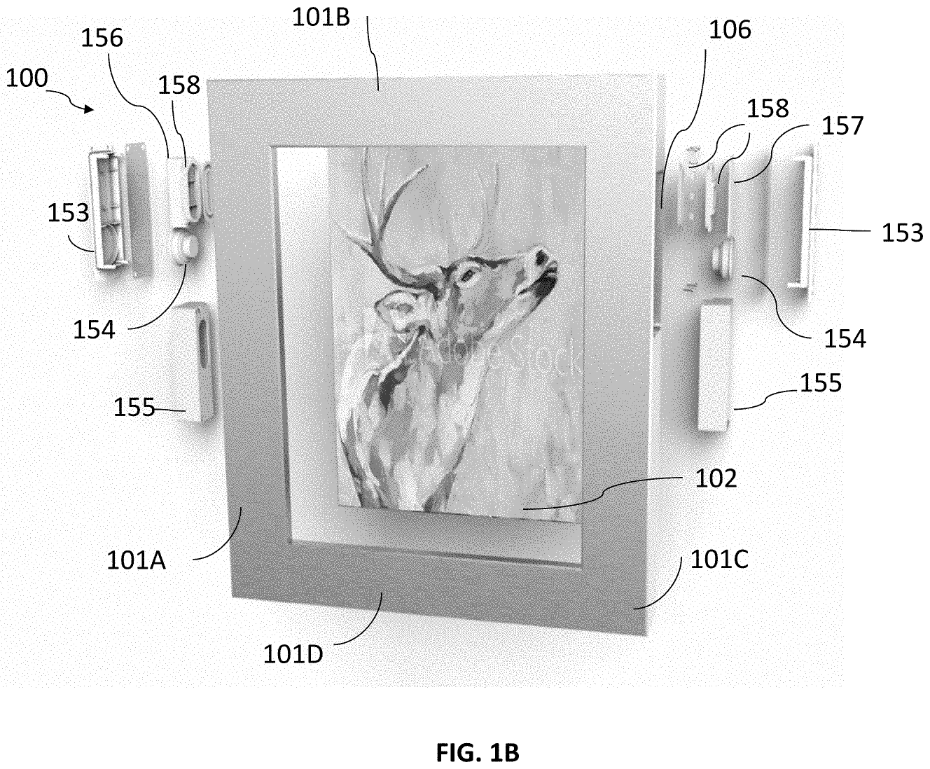

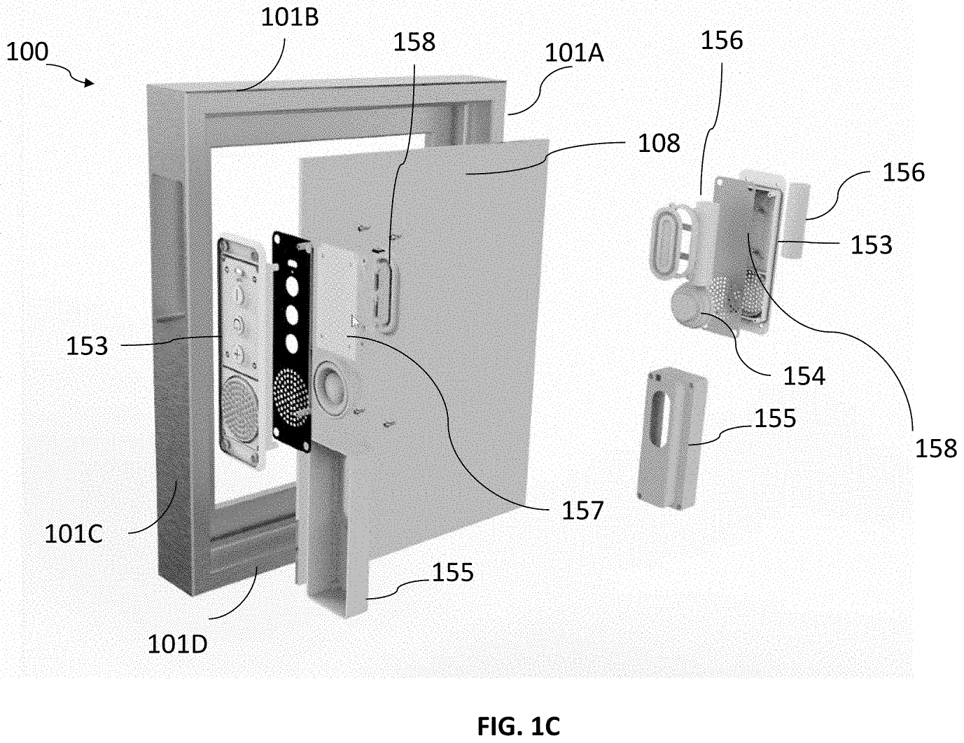

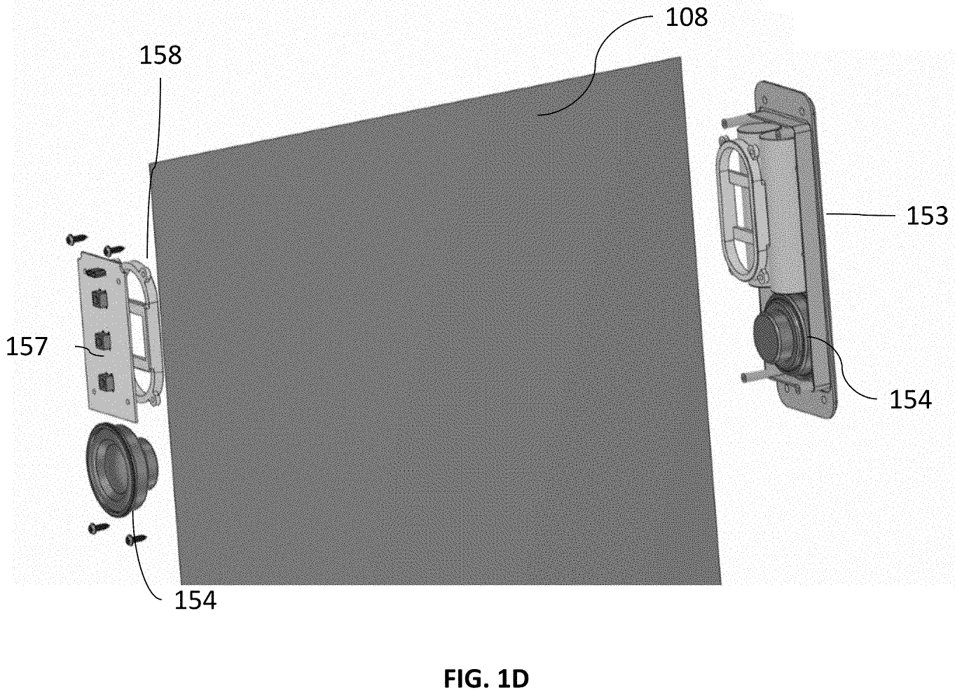

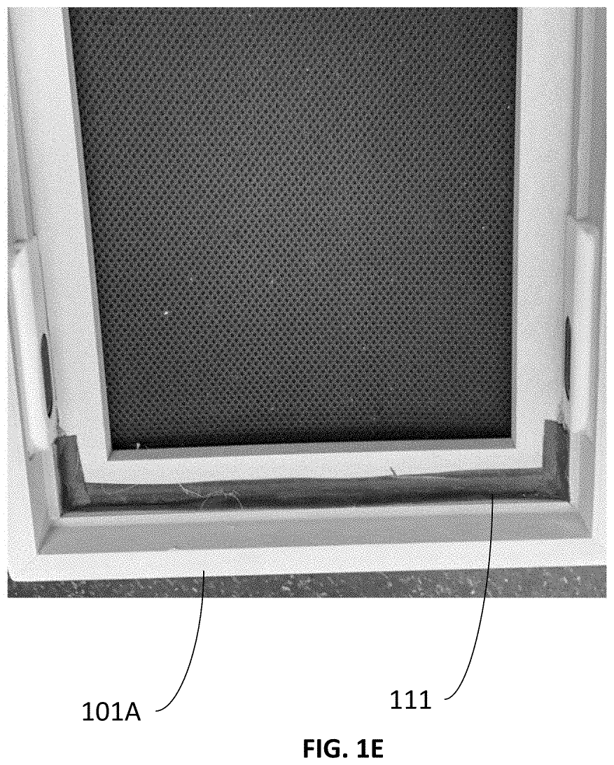

FIG. 1A depicts a picture frame for printed photographs (or other artwork) on canvas, according to a first exemplary embodiment of the present invention. In FIG. 1A, a picture frame 100 has four frame elements 101A, 101B, 101C, and 101D with frame element 101A corresponding to a first side, frame element 101B corresponding to a second side opposite the first side, frame element 10C corresponding to a third side, and frame element 10D corresponding to a fourth side opposite the third side. The corresponding sides of the four frame elements 101A, 101B, 101C, 101D provide the frame 100 with a generally rectangular or square shape. In exemplary embodiments, frame elements 101A, 101B, 101C, and 101D can be made of wood, metal, steel, plastic, polymer, other rigid material, to name a few.

In exemplary embodiments, picture frame 100 may be configured to be mounted on a wall and/or may be configured to be free-standing, with or without a support stand (not shown). For example, picture frame 100 can be free-standing on the floor, a table, leaned against a wall or solid surface or can be attached to a stand for placing the frame on table or desk, to name a few.

A canvas material 102 may be mounted within the frame 100, with the frame elements 101A, 10B, 101C, 101D surrounding and holding the canvas material 102 in place. In the industry, a canvas material on which photographs or other artwork are printed or otherwise rendered is often referred to as “chemical canvas.” As disclosed herein, the term chemical canvas refers to canvas or canvas-like material on which a photograph or image can be rendered. According to exemplary embodiments, the chemical canvas on which images can be rendered is a 190-gram chemical fiber canvas that is 100 percent polyester, although it should be appreciated that the present invention is not limited to a specific type of chemical canvas.

In exemplary embodiments, the frame 100 may have a common picture frame size, such as, for example, 11 inches×14 inches. Various other commonly used dimensions are also possible, such as 8 inches×10 inches and 16 inches×20 inches. In exemplary embodiments, the frame elements 101A, 101B, 101C, 101D may be sized to accommodate one or more speakers of various sizes, such as, for example, 31-millimeter wireless speakers that are currently available for sale.

Picture frame 100 has integrated therein (or, alternatively, mounted thereon) a standalone speaker system, generally designated by reference number 150. The speaker system 150 includes at least one speaker component that includes an audio speaker 154, and in a preferred exemplary embodiment includes at least two speaker components arranged around the frame with each speaker component having a corresponding audio speaker 154. In exemplary embodiments, one or more of the frame elements 101A, 101B, 101C, 101D may include openings 106 configured to house a corresponding one of the speaker components of the speaker system 150.

One of the speaker components may include a manual control panel 153 that controls the speakers 154 within the speaker components. The manual control panel 153 is exposed through an opening 106 in a corresponding one of the frame elements 101A, 101B, 101C, 101D so that a user may access various controls on the panel 153, such as, for example, volume, equalizer, track selection, fast forward, rewind, repeat and power controls, to name a few. The manual control panel 153 may be accessible at the front, back or side of the corresponding one of the frame elements 101A, 101B, 101C, 101D. In exemplary embodiments, each audio speaker 154 may be associated with a corresponding control panel 153, or a single control panel 153 may be provided to control all speakers within the speaker system 150.

Exemplary embodiments of the present disclosure may include one or more types of speakers, such as, for example, traditional or miniature loudspeakers, woofers, subwoofers, or soundbars. In exemplary embodiments, the speakers may be wirelessly controlled, such as Bluetooth or WiFi speakers, or may be controlled manually. In a preferred exemplary embodiment, the speakers 154 are wireless speakers so that the speaker system 150 may be seamlessly integrated into the frame 100 without components that might otherwise hinder the aesthetics of the frame 100 and artwork held therein.

In the exemplary embodiment shown in FIG. 1B, the speaker system 150 includes two speaker components arranged at opposite sides of the frame 100, with each speaker component including a speaker 154, and at least one speaker component including a manual control panel 153 disposed immediately adjacent a corresponding speaker 154. It should be appreciated that the present invention is not limited to this specific arrangement of speakers 154 and control panels 153, and in other exemplary embodiments speakers 154 and manual control panels 153 can be disposed spatially distant from one another. For example, manual control panel 153 may be disposed on one side of a frame element 101A, 101B, 101C, 101D with the corresponding speaker 154 disposed on another side of the same frame element or on a different frame element. In exemplary embodiments, rather than each speaker 154 being disposed at an outer exposed surface of a corresponding one of the frame elements 101A, 101B, 101C, 101D, one or more of the speakers 154 may be disposed or integrated with the interior portion of picture frame 100 so that, when activated, the internal one or more speakers play audio through the canvas material 102 on which the photograph or artwork is rendered.

In exemplary embodiments, picture frame 100 can also include instrumentality to have speaker 154 controlled remotely, such as, for example via WiFi or other similar near-field communication protocol known in the art. Such instrumentation can be directly integrated with speaker 154. Alternatively, speaker 154 may be controlled via a dedicated application program installed on a mobile phone, whereby the mobile phone is in communication with speaker 154 via a WiFi, Bluetooth, or other near-field communication protocol known in the art.

In the exemplary embodiment of FIG. 1A, the at least one speaker 154 may be powered by one or more rechargeable batteries 156 which can be recharged by way of an adapter that can be plugged into an electrical outlet. In exemplary embodiments, the speaker batteries can be recharged using a capacitive charger. In still other exemplary embodiments, the speaker batteries can be recharged wirelessly via inductive or magnetic resonance charging. The batteries may be provided as part of a battery pack that can be easily removed from the speaker system 150 for charging at a different location so that unsightly charging components do not need to be attached to the frame 100.

As shown in the exploded view of FIG. 1B, speaker system 150 includes housings 155 for each corresponding speaker component. Various sub-components of the speaker component may be disposed within the housing 155, including, for example, audio speaker 154, batteries 156, a circuit board 157 holding electronic components such as a receiver, controller and/or an amplifier, and mounting components 158. Speaker 154 is depicted as a component that is disposed beneath manual control panel 153, and which plays audio through a pattern of holes or screen in the control panel 153 (see FIG. 1A). The exploded view depicted in FIG. 1B is a front view of picture frame 100.

FIG. 1C depicts a rear exploded view of the picture frame 100 according to an exemplary embodiment of the present invention. In addition to the components depicted in FIGS. 1A and 1B, FIG. 1C further shows back plate 108, which has disposed on its front side canvas material 102 (not shown), and which is inserted into picture frame 100 between frame elements 101A-D.

FIG. 1D depicts a partial exploded view of the picture frame 100 according to an exemplary embodiment of the present invention, showing how speaker 154 is seated behind control panel 153.

FIG. 1E depicts an interior electrical connection of the picture frame 100 according to an exemplary embodiment of the present invention. As shown in the figure, connector 111 runs along the back of one or more of the frame elements 101A, 101B, 101C, 101D, providing electrical connectivity within picture frame 100 and between the speaker components of the speaker system 150. In exemplary embodiments where two or more speakers are arranged around the frame 100, each speaker may be configured to produce audio output within a specific frequency range that is different from the frequency range output by other speakers, so that the two or more speakers together produce a full range of frequencies. In exemplary embodiments, the two or more speakers may be configured to produce two or more different stereo images (e.g., a rear stereo effect and a front stereo effect). This may be useful particularly in high fidelity audio applications and/or to product a surround sound effect.

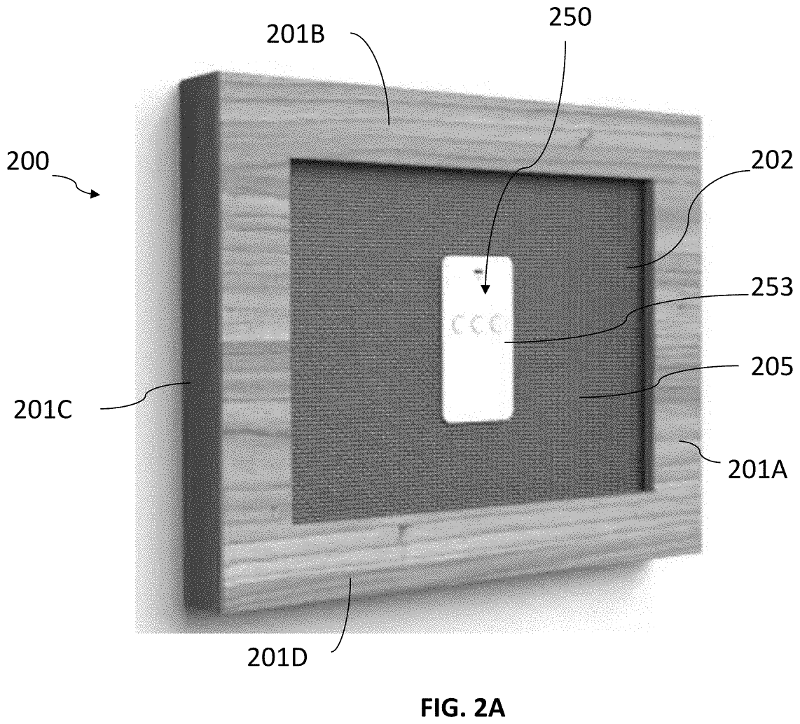

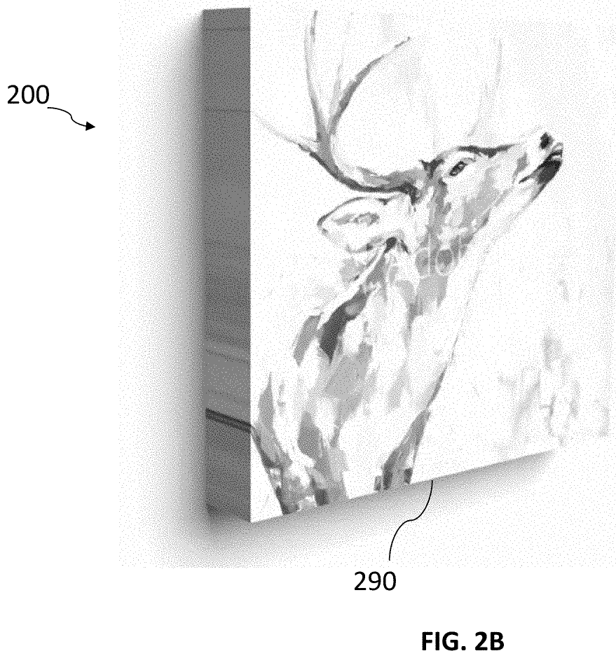

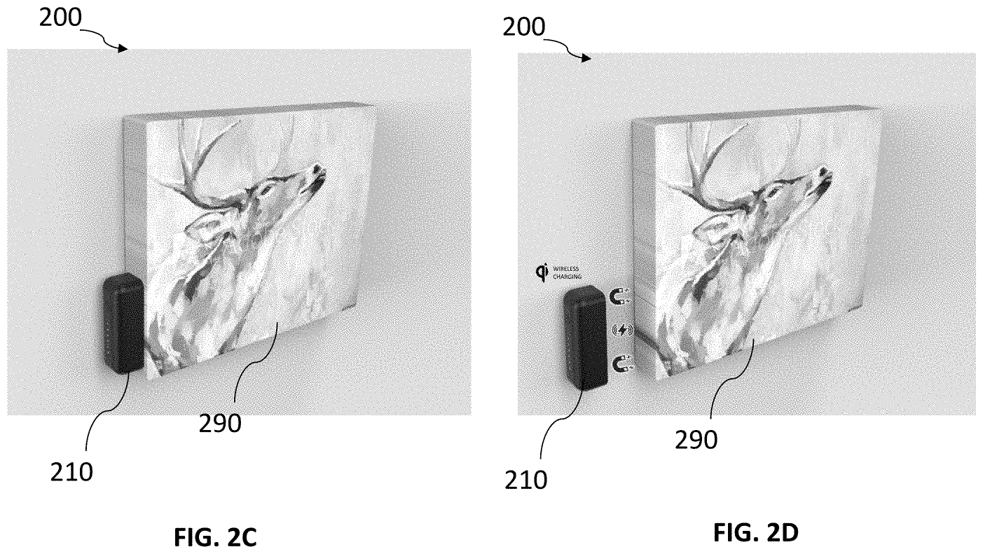

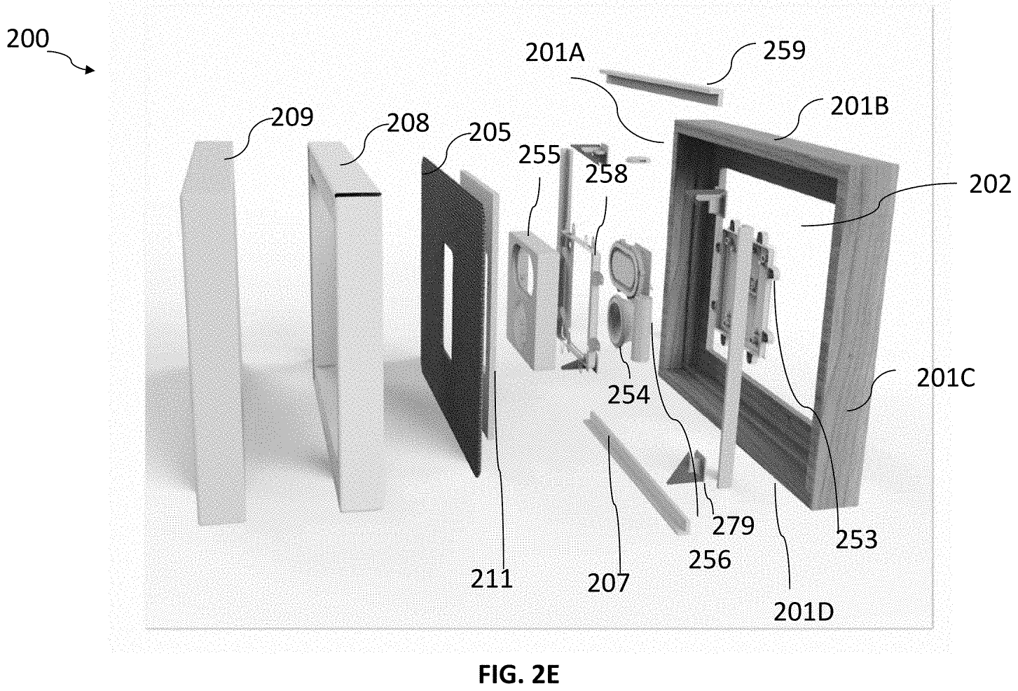

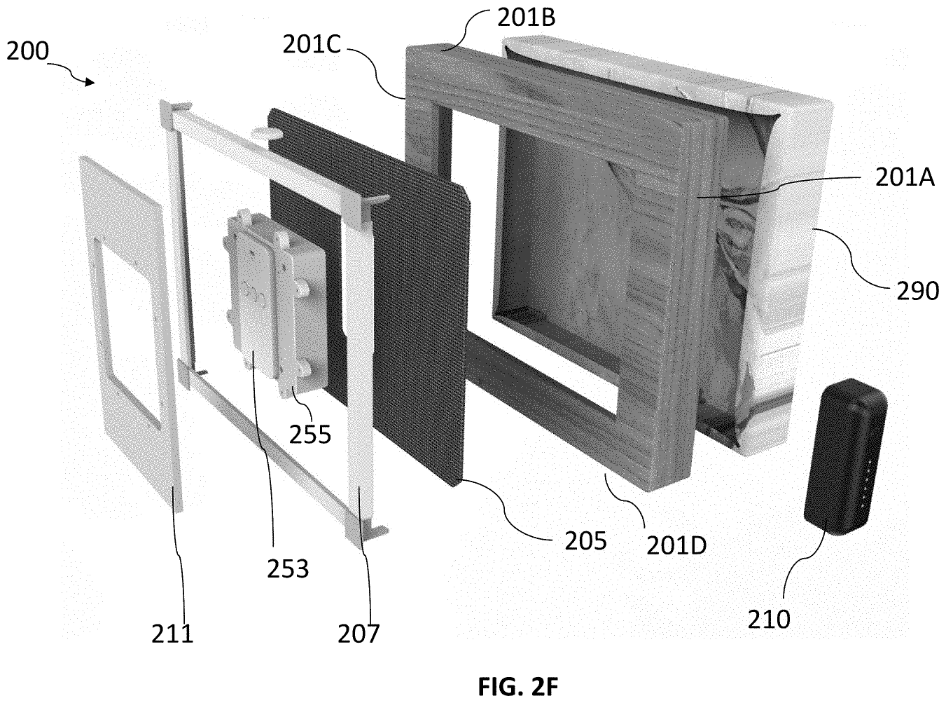

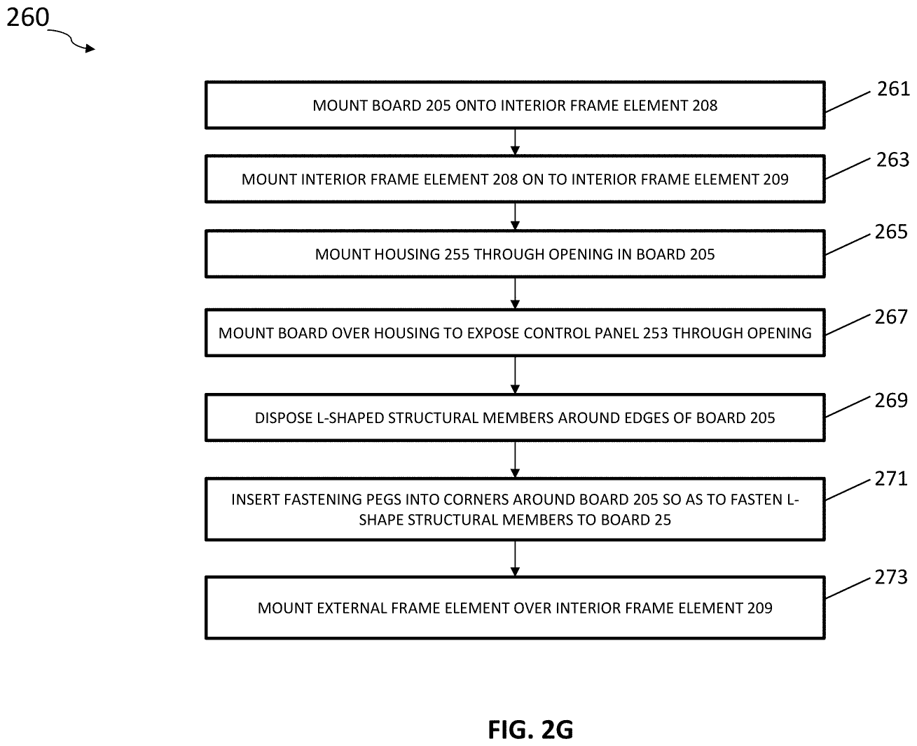

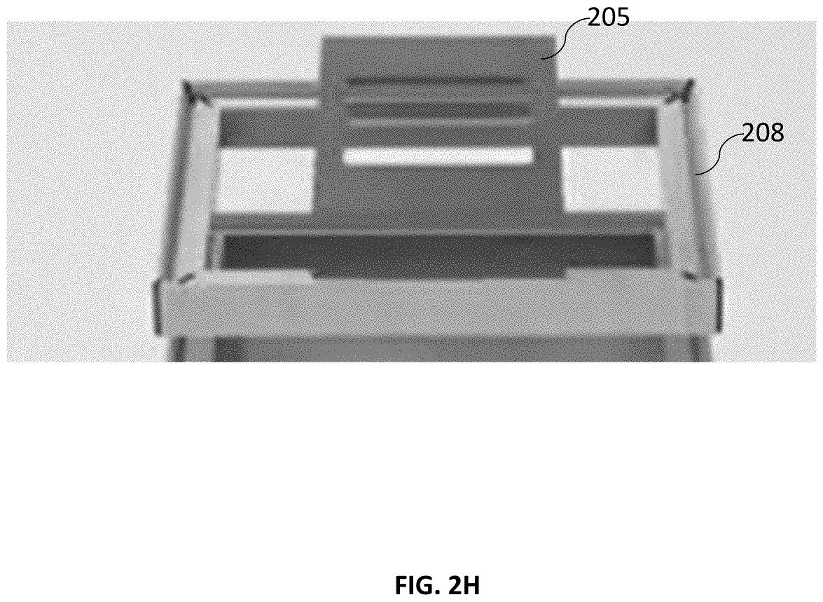

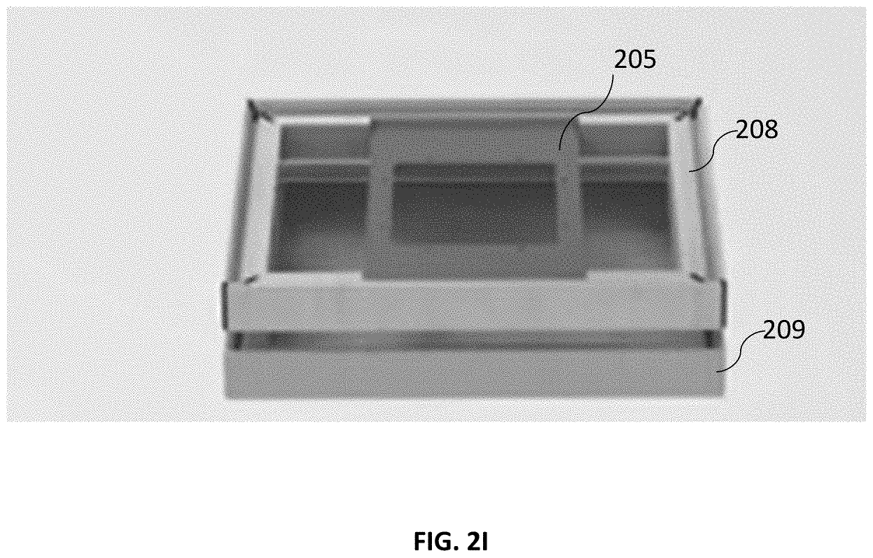

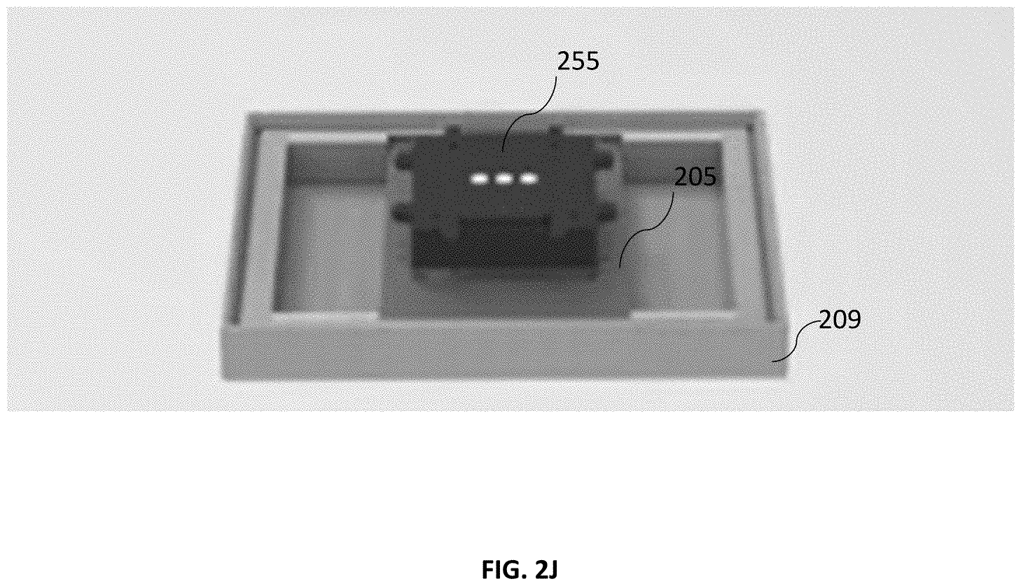

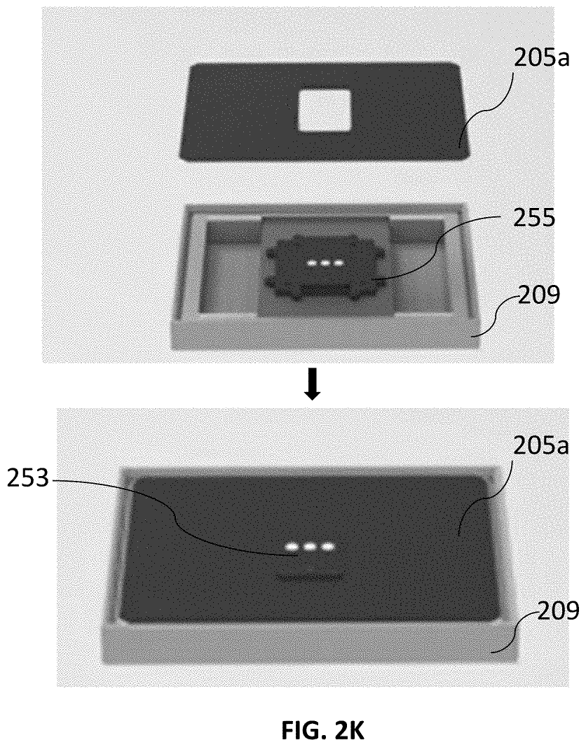

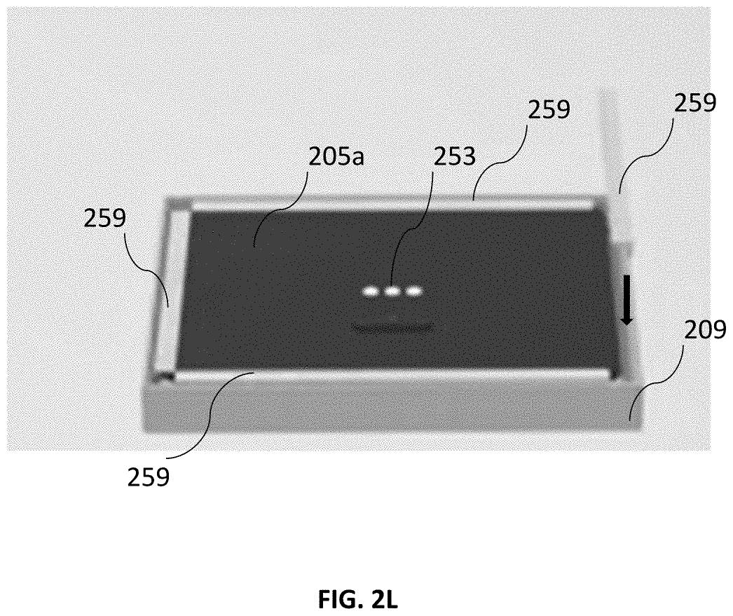

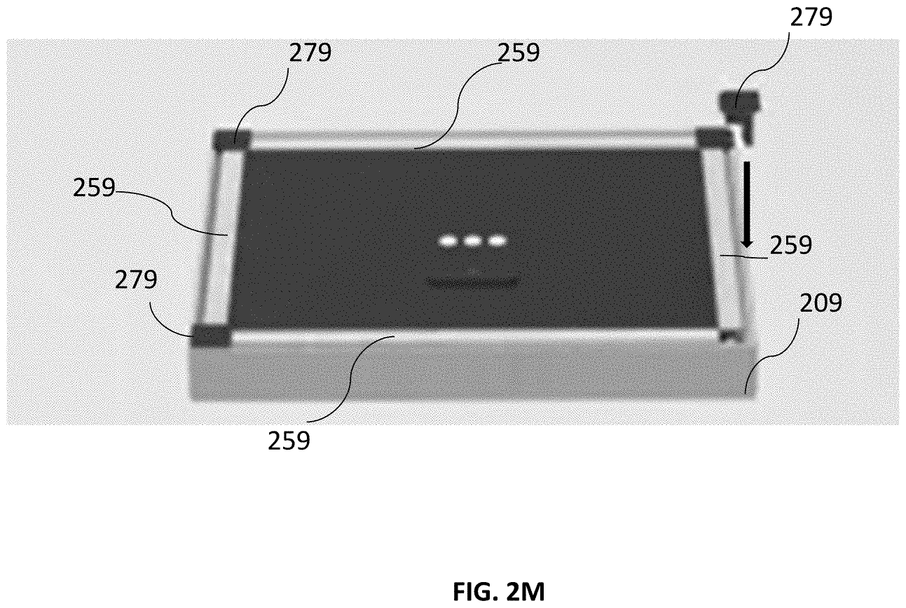

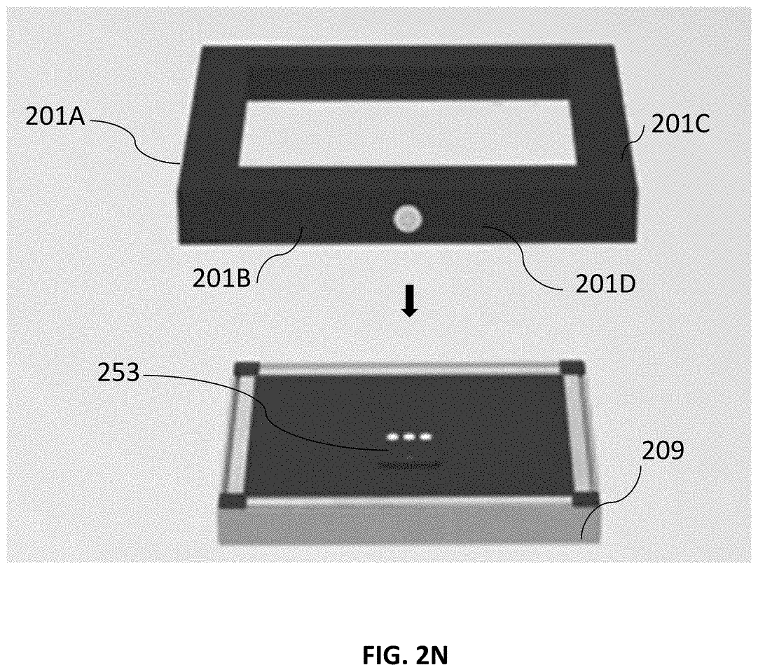

FIGS. 2A-2F illustrate a picture frame, generally designated by reference number 200, for printed photographs on canvas, according to another exemplary embodiment of the present invention. This exemplary embodiment differs from the previously described exemplary embodiment in that the canvas material is mounted over the frame 200 rather than within the frame. As in the previous exemplary embodiment, frame 200 may include a speaker system 250 and frame elements 201A, 201B, 201C, 201D. As best shown in FIG. 2E, the rear of the frame elements 201A, 201B, 201C, 201D form a cavity 202.

The speaker system 250 includes a speaker component that in turn includes a control panel 253 and audio speaker 254. The speaker component may be mounted on a board 205 that is itself mounted in the cavity 202 and held in place by the frame elements 201A, 201B, 201C, 201D. The board 205 may be made of canvas or canvas-like material. The speaker component is mounted such that the control panel 253 is exposed at the rear of the frame 200 and the audio speaker 254 is exposed at the front of the frame 200 so that the speaker 254 plays audio through the canvas material Although the figures show the control panel 253 and speaker 254 mounted at the same location on the board 205 so that they are directly opposite from one another, it should be appreciated that the control panel 253 may be mounted on the board 205 at a location that is different from a location at which the speaker 254 is mounted.

As in the previous exemplary embodiment, the speaker component includes housing 255, audio speaker 254, one or more batteries 256, a circuit board (not shown) holding electronic components such as a receiver, controller and/or an amplifier, and mounting components 258. In exemplary embodiments, the one or more batteries 256 may be rechargeable batteries that can be recharged via an electrical adapter, a capacitive charger, or a wireless inductive or magnetic resonance charger.

The exemplary embodiment depicted in FIG. 2A is an “empty” picture frame, that is, a picture frame that does not have a chemical canvas on which an image can be rendered. As shown in FIG. 2B, in exemplary embodiments, a chemical canvas 290 having its own internal frame may be placed over the frame 200. Alternatively, as shown in FIG. 2F, a chemical canvas 290 without its own internal frame may be stretched around or wrapped snugly around frame elements 201A, 201B, 201C, 201D and fastened at the rear of picture frame 200. Thus, when a chemical canvas is attached to picture frame 200, the sides of frame elements 201A, 201B, 201C, 201D are covered with the chemical canvas on which the image is rendered.

FIG. 2C depicts a front view of the picture frame 200 according to an exemplary embodiment. A charger 210 may be connected to a plug (now shown) disposed on the side of the picture frame 200. In exemplary embodiments, the plug may be accessible through an opening in the canvas material 290 and through an opening in one of the frame elements 201A, 201B, 201C, 201D over which the canvas material 290 is deployed. Charger 210 is configured to recharge a rechargeable battery that is disposed within picture frame 200.

FIG. 2D depicts an arrangement that is similar to that shown in FIG. 2C except that the charger 210 is a wireless charger. In FIG. 2D, charger 210 wirelessly charges a rechargeable battery that is disposed within picture frame 200. Thus, charger 210 in FIG. 2D does not require being plugged in, which obviates the need for openings in the canvas material 290 and one of the frame elements 201A, 201B, 201C, 201D to accommodate an electrical plug. In this regard, the frame 200 may include a receiver coil 207 that wirelessly couples with the wireless charger 210 to transfer power to the rechargeable batteries 256. In exemplary embodiments, the frame element 201A, 201B, 201C, 201D at which the receiver coil 207 is located may be provided with a marking and/or a structural indicator (e.g., a protrusion or indentation) to indicate to a user the location where the wireless charger 210 should be placed.

As shown in FIG. 2E, the frame 200 may include interior frame elements 208, 209 and 211 to provide further support to the various components of the speaker system 250 as well as the canvas 290 disposed over the frame 200.

FIG. 2G depicts a flow diagram of a method 260 for assembling a picture frame in accordance with exemplary embodiments of the present invention. The steps of method 260 can be executed in the sequence shown in FIG. 2G or, alternatively, can be executed in another sequence without departing from the spirit of the present invention. Further, method 260 as presented in FIG. 2G is adapted to assembly of the picture frame 200 as shown in FIG. 2E. Method 260, however, can be adapted for assembly of other depicted embodiments, such as, for example, the embodiment depicted in FIG. 2F. Further, one or more of the steps of method 260 can be carried out by automated assembly tools and machinery or, alternatively, can be carried out manually. It should be noted that, in carrying out method 260, some of the steps can be carried out with the aid of assembly tools and machinery, while others can be performed manually. In addition, method 260 is described below in connection with the components associated with the embodiment of picture frame 200 depicted in FIG. 2E.

Method 260 begins as step 261. At step 261, board 205 is first mounted on to interior frame element 208. FIG. 2H depicts an exemplary mounting process described in connection with step 261. As shown in FIG. 2H, board 205 is mounted upon interior frame element 208.

After this mounting step, at step 263, interior frame element 208 (with board 205 already mounted thereon) is itself mounted on to interior frame element 209. As described above, interior frame elements 208 and 209 provide support to the various components of the speaker system and canvas disposed over frame 200.

FIG. 2I depicts an exemplary mounting process as described in connection with step 263. As shown in FIG. 2I, interior frame element 208 is mounted upon and fitted inside of interior frame element 209, such that the exterior surfaces of interior frame element 208 abut the interior surfaces of interior frame element 209.

Next, at step 265, housing 255 is mounted through an opening in board 205. According to embodiments, housing 255 encloses one or more audio speakers, one or more batteries, and a circuit board (not shown) having mounted thereon a receiver, controller and/or an amplifier. Board 205 has an opening that can accommodate a front portion of housing 255, such that only the front portion of housing 255 is inserted through the opening in board 205. The opening in board 205 provides a snug fit for the front portion of housing 255, thereby securing housing 255 in place. In embodiments, a rear portion of housing 255 has disposed thereon a control panel for controlling the speaker(s) enclosed within the housing. An example of such a control panel is control panel 253 shown in FIG. 2E.

FIG. 2J depicts an exemplary mounting process as described in connection with step 265. As shown in FIG. 2J, housing 255 is mounted on board 205 such that the front portion of housing 255 fits through the opening in board 205.

At step 267, a second board (similar to board 205) is mounted over the rear portion of housing 255. Similar to board 205, the second board has an opening through which the control panel disposed on the rear portion of housing 255 can fit. Thus, after executed step 267, housing 255 is sandwiched between two boards 205, one of which has an opening through which the front portion of housing 255 is fit and the other which has an opening through which the rear portion of housing 255 is fit, thereby exposing the control panel.

FIG. 2K shows an exemplary mounting process as described in connection with step 267. As shown in the top figure, board 205a (which, in embodiments, is made of a similar material as board 205) is mounted atop housing 205. Board 205a has an opening that is large enough to accommodate the rear side of housing 255, which, as shown, has control panel 253 disposed thereon. Once mounting of board 205a is complete, as shown in the bottom figure, control panel 253 is exposed and accessible through the opening of board 205a.

Next, at step 269, a plurality of L-shaped structural members (such as members 259 depicted in FIG. 2E) are disposed around the edges of board 205 that is itself disposed over the rear portion of housing 255. One L-shaped structural member is disposed along each of the side edges of board 205, where a vertical portion of each structural member fits within a gap between board 205 and interior frame element 208. Once the vertical portions of the L-shaped structural members have been fitted into the gaps, a horizontal portion of the L-shaped structural members then fits over the surface of board 205, thereby securing board 205 in place.

According to embodiments, the L-shaped structural members have lengths that are equal to the lengths of the edges of board 205, but which are less than the lengths of the sides of interior frame elements 208. Thus, once the L-shaped structural members have been disposed as described above, an opening is formed at each of the corners between the edges of adjacent L-shaped structural members and the edge of interior frame element 208.

FIG. 2L depicts an exemplary process of disposing L-shaped structural members around the edges of boards 205a and 205. As shown in FIG. 2L, L-shaped structural members 259 are disposed such that a lower portion of each member is disposed in a gap formed between board 205a (and board 205) and a side of interior frame element 209. The upper portion of each L-shaped structural member 259 is disposed over a portion of board 205a so as to secure board 205a in place. It should be noted that the length of each L-shaped structural member 259 is less than the sides of interior frame element 259, thereby leaving an exposed corner between adjacent members 259.

At step 271, fastening pegs are then inserted into each of the above mentioned corners around board 205. Examples of such pegs are depicted in FIG. 2E as pegs 279. According to embodiments, fastening pegs 279 are shaped so that a lower part of the peg fits into the corner formed between the edges of adjacent L-shaped structural members. An upper part of each peg 279, however, is substantially flat and has a larger area than the corner into which the lower part is inserted. Thus, after insertion, each peg 279 partially overlaps adjacent L-shaped structural members, while the lower part of the peg extends into the opening formed by the corner. The adjacent structural members at each corner are thereby held in place by the corresponding peg inserted at that corner.

FIG. 2M depicts the disposal of fastening pegs 279 in the exposed corners around the perimeter of interior frame element 259. Ash shown, pegs 279 are shaped such that a lower part of the peg fits into each corner, while an upper part of the peg fits over a portion of adjacent L-shaped structural members 259, which secures each pair of structural members in place.

At step 273, an external frame element is mounted over interior frame element 209. An example of the external frame element is shown in FIG. 2E as frame elements 201A-201D. Thus, after the external frame element has been mounted, board 205 is exposed through the external frame element, while the control panel (such as control panel 253) is exposed through the opening in board 205, enabling manual or wireless control of the speakers enclosed within housing 255.

FIG. 2N depicts an exemplary disposal of frame elements 201A-201D over interior frame element 209 as described in connection with step 273. As shown in the figure, once frame elements 201A-201D are fitted over interior frame element 209, control panel 253 is exposed and accessible through frame elements 201A-201D.

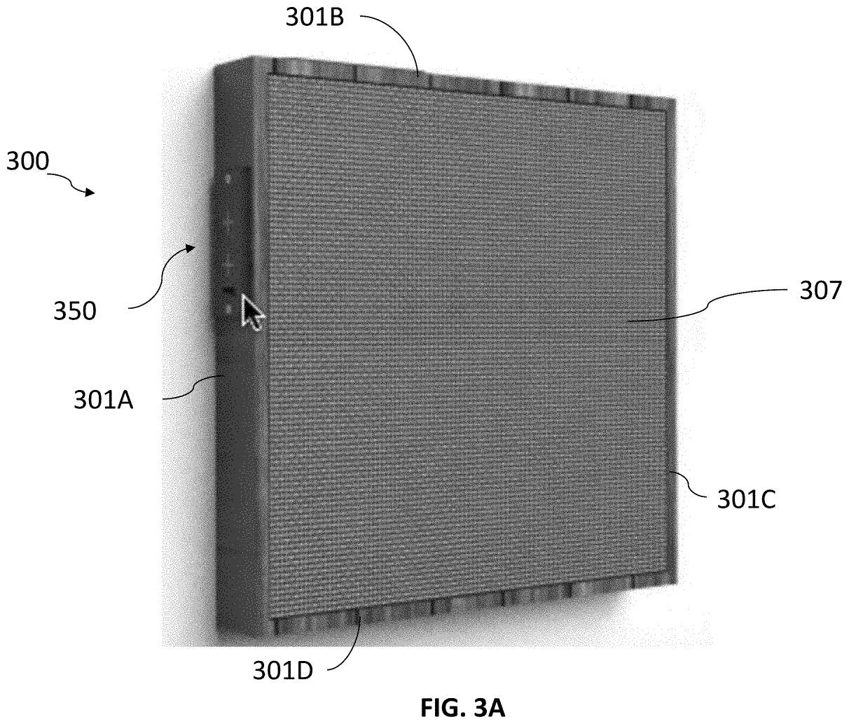

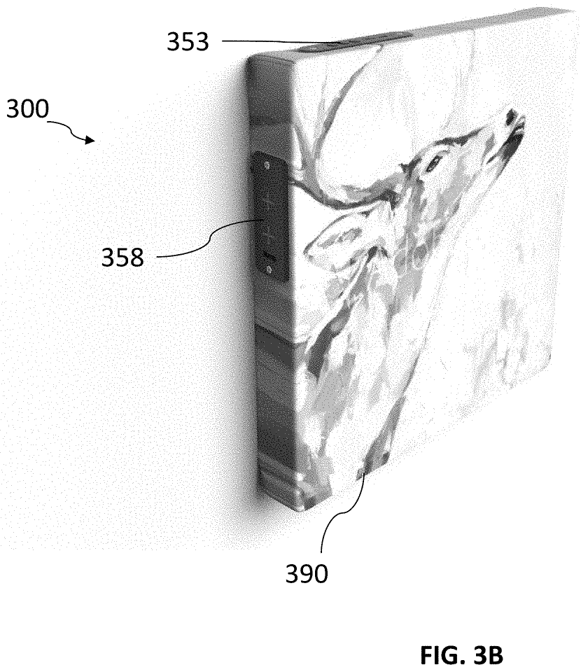

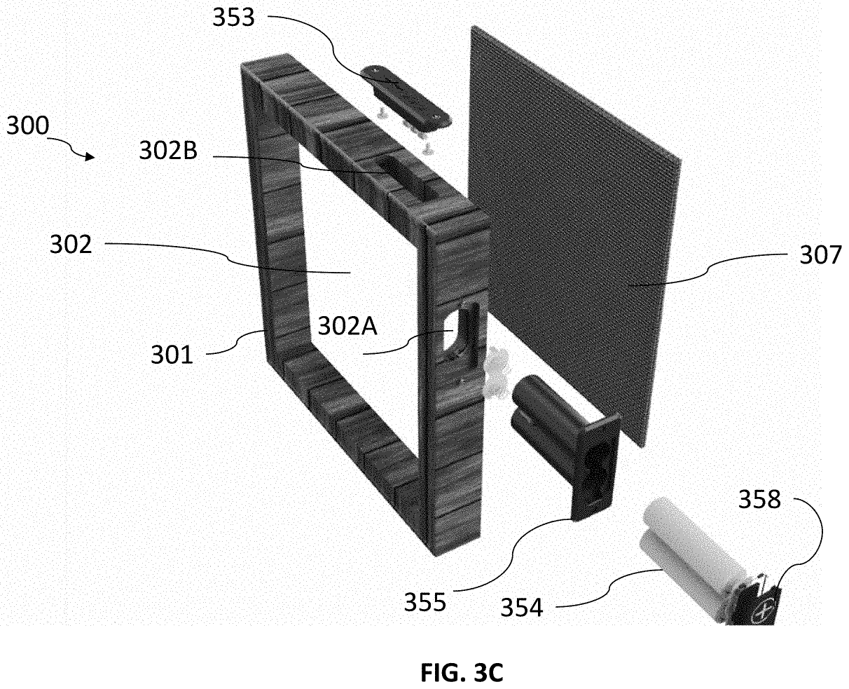

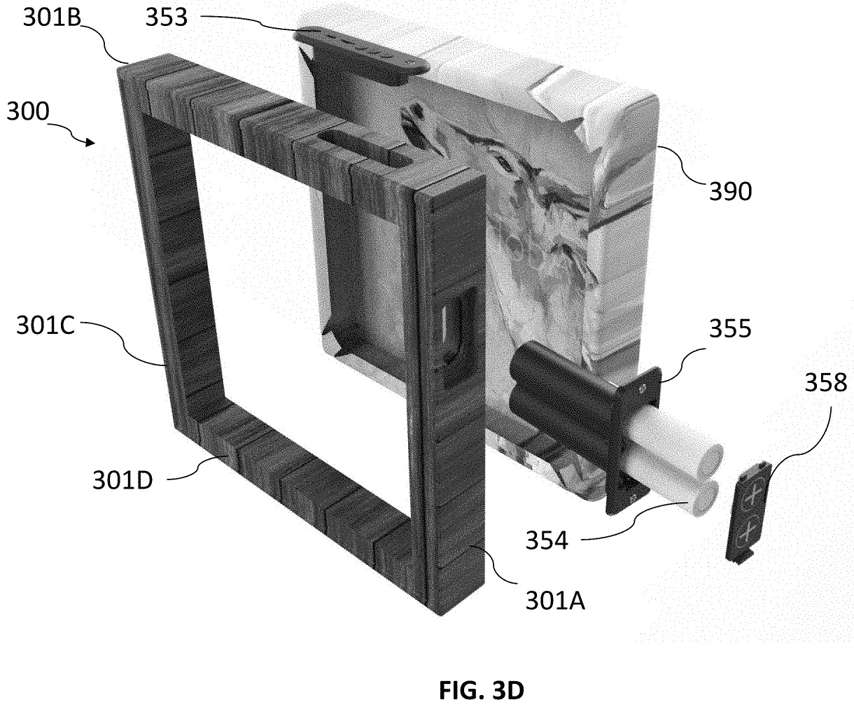

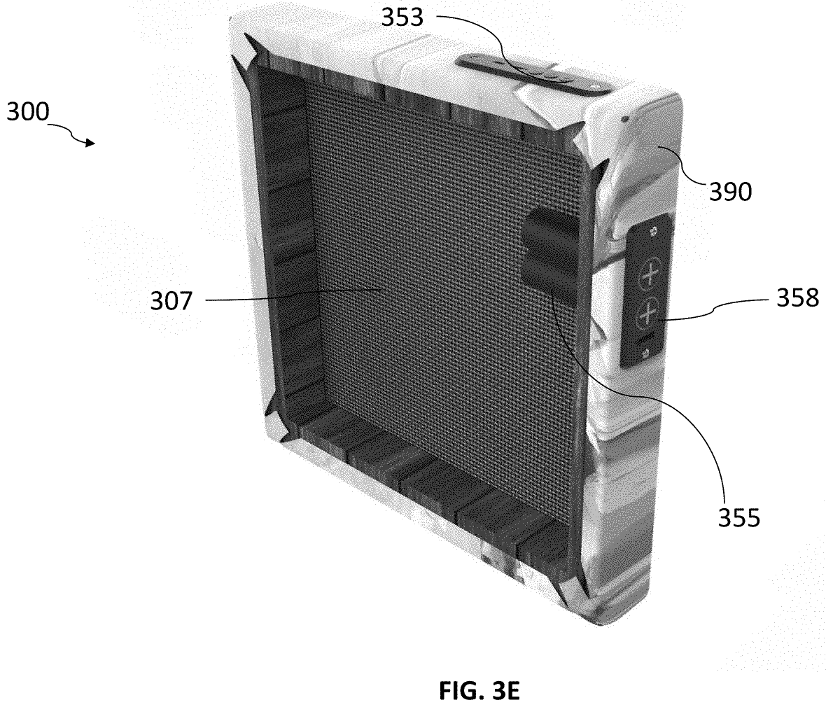

FIGS. 3A-3E illustrate a picture frame, generally designated by reference number 300, for printed photographs on canvas, according to another exemplary embodiment of the present invention. As in the previous exemplary embodiments, frame 300 may include a speaker system 350 and frame elements 301A, 301B, 301C, 301D. The rear of the frame elements 301A, 301B, 301C, 301D form a cavity 302. In this exemplary embodiment, a canvas material 390 is mounted directly onto the frame elements 301A, 301B, 301C, 301D.

The frame 300 includes a back plate 307, which is made of a canvas or canvas-like material and which is mounted within frame elements 301A, 301B, 301C, 301D. Back plate 307 provides support to the frame elements 301A, 301B, 301C, 301D and provides a surface on which a canvas material 290 (such as a chemical canvas) can be wrapped around for display of an image rendered thereon.

As best shown in FIGS. 3C and 3D, frame element 301A includes an opening 302A and frame element 301B includes an opening 302B. A battery housing 355 may be disposed within the opening 302A and a manual control panel 353 may be disposed within the opening 302B. It should be appreciated that the arrangement of the battery housing 355 and control panel 353 is not limited by this description, and in other exemplary embodiments the battery housing 355 and control panel 353 may be arranged at any point around the frame 300, either on the same frame element or on differing frame elements. The battery housing 355 may include a removable plate 358 that allows access to one or more batteries 354 for replacement or recharging.

As with the previously described exemplary embodiment, the speakers (not depicted) can be disposed within the frame elements 301A, 301B, 301C, 301D and/or behind the canvas material such that the speaker plays audio through the canvas material.

The battery compartment can be disposed along any of the sides of frame elements 301A, 301B, 301C, 301D or on the rear of picture frame 300. The one or more batteries 354 installed in the battery compartment can be rechargeable batteries or disposable batteries.

FIG. 3B depicts a front view of the picture frame 300 according to an exemplary embodiment of the present invention. As shown in the figure, canvas material 390 is stretched and wrapped snugly over frame elements 301A, 301B, 301C, 301D. Canvas material 390 may have an opening in the side through which plate 358 may be accessed. Plate 358 may be removed to access one or more batteries located in the battery compartment 355. In exemplary embodiments, a template may be provided that may be placed over the canvas material 390 before mounting to the frame 300, where the template indicates the position of the openings around the frame elements 301A, 301B, 301C, 301D. The template may then be used to cut or the otherwise form openings at appropriate locations within the canvas material 390 so that when the canvas material 390 is mounted on the frame 300, the openings are aligned with the openings 302A, 302B.

In addition, FIG. 3B depicts the control panel 353 that may be disposed along the top side of one of the frame elements 301A, 301B, 301C, 301D. As in the previously described exemplary embodiments, control panel 353 may include various controls, such as, for example, volume, equalizer, track selection, fast forward, rewind, repeat and power controls, to name a few. As shown, control panel 353 may be accessible through an opening in canvas material 390.

FIG. 3C depicts an exploded view of the picture frame 300 according to an exemplary embodiment of the present invention. As shown, the control panel 353 is disposed along a top portion of one of the frame elements 301A, 301B, 301C, 301D. Battery compartment 355 is inserted into a side opening of another one of the frame elements 301A, 301B, 301C, 301D. One or more batteries 354 are inserted into battery compartment 355. Battery compartment 355 is covered with plate 358. In exemplary embodiments, circuitry is provided to supply power from batteries 354 to the speaker system 350.

FIG. 3D depicts another exploded view of the picture frame 300 according to an exemplary embodiment of the present invention. FIG. 3D includes the same components depicted in FIG. 3C. In addition, FIG. 3D shows canvas material 390, on which an image is rendered. As shown in the figure, canvas material 390 is mounted directly on frame elements 301A, 301B, 301C, 301D.

FIG. 3E depicts a rear view of the picture frame 300 according to an exemplary embodiment of the present invention. In this view, batteries 354 have been installed into battery compartment 355. Battery compartment 355 is installed through a side opening in frame elements 301A, 301B, 301C, 301D. Plate 358 is then placed over battery compartment 355 to hold the compartment in place with respect to frame elements 301A, 301B, 301C, 301D. Control panel 353 is installed in an opening along the top side of one of the frame elements 301A, 301B, 301C, 301D.

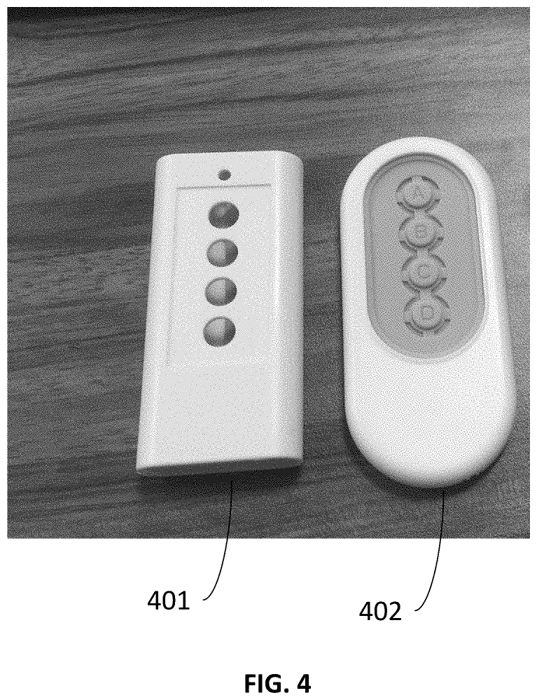

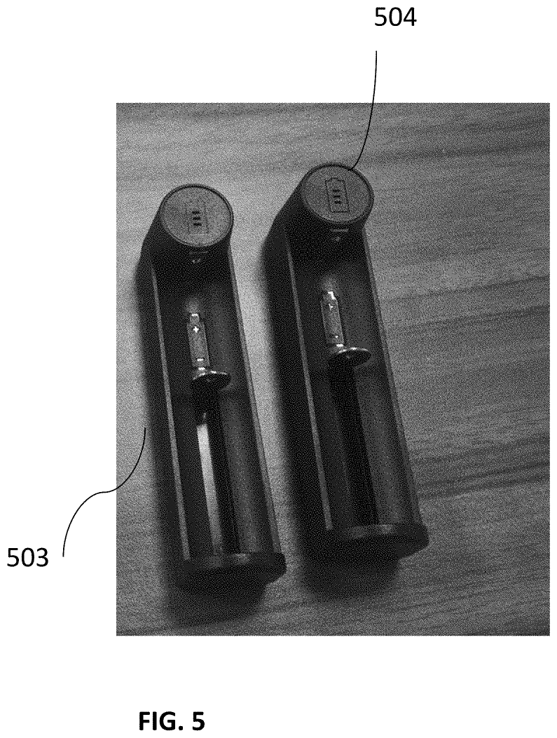

FIGS. 4 and 5 depict additional components that may be included with any of the exemplary embodiments of the present invention. FIG. 4 depicts remote controls 401 and 402, which communicate wirelessly with speakers installed in the picture frame. Remote controls 401 and 402 provide an end user with the ability to power on and power off the speakers, as well as other controls such as, for example, volume, equalizer, and balance among two or more installed speakers, to name a few. FIG. 5 depicts battery chargers 503 and 504, which are configured to charge rechargeable batteries useable with exemplary embodiments of the present invention.

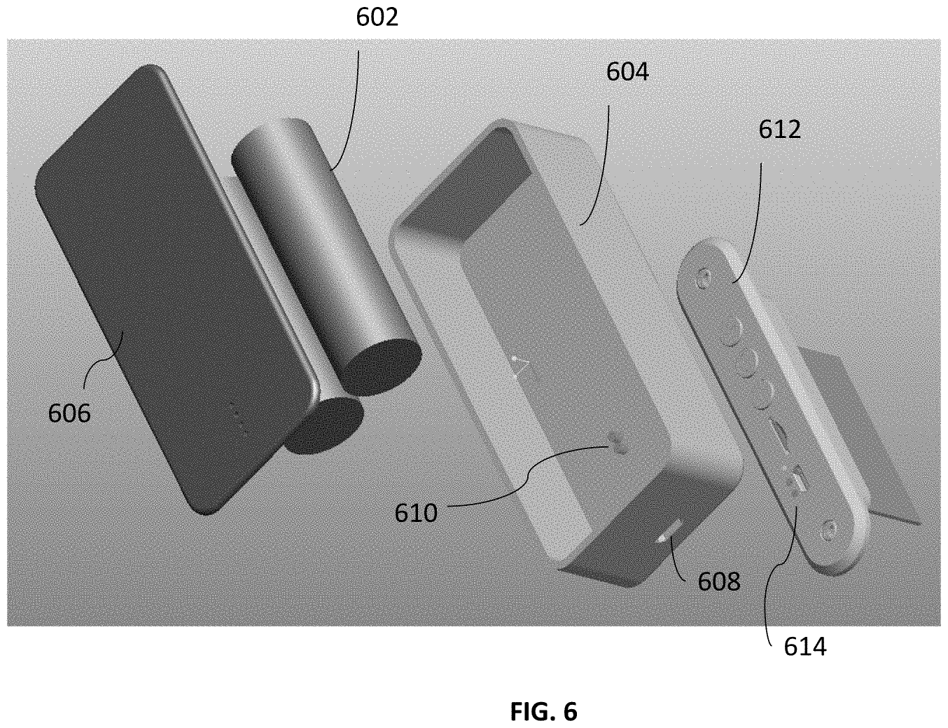

FIG. 6 depicts a component that can be used to externally and wirelessly power the speakers and other electrical components disposed within the picture frame, in accordance with exemplary embodiments. As shown in FIG. 6, one or more rechargeable batteries 602 are housed in an external battery pack 604. The batteries 602 are held within battery pack 604 by back plate 606, which keeps the batteries 606 stably seated within the pack. In exemplary embodiments, the back plate 606 may be held in place by a snap-fit or sliding tab so as to be easily removable for access to the batteries 602. Battery pack 604 includes an opening 608 through which an electrical adapter or plug (not shown in the figure) can be inserted in order to charge batteries 602.

Once batteries 602 are charged, the batteries are capable of powering the speakers and other electrical components disposed within any of the picture frame embodiments disclosed herein. According to exemplary embodiments, batteries 602 include one or more access points (not shown) that engage pins 610. As shown, pins 610, in embodiments, are disposed on an interior surface within battery pack 604. Each of pins 610 has a first end that engages an access point in one or more of batteries 602. Each of pins 610 also has a second end that extends through the surface of battery back 604 and is exposed to the exterior of the pack. Each of pins 610 comprise conductive material capable of conducting electricity from batteries 602 at the first end to an electrical connection at the second thereof.

In exemplary embodiments, the second ends of pins 610 are configured to engage pin receptacles 614, which, in turn, are electrically connected to the speakers and electrical components disposed within the picture frame. According to embodiments, pin receptacles 614 are disposed on the front of a control panel, such as control panel 612 shown in FIG. 6. It should be noted that any of the control panels previously depicted in the embodiments above can be modified to include pin receptacles 614. In embodiments, fully recharged batteries 602 are housed in pack 604 and engaged with the first end of pins 610. The second ends of pins 610 are then engaged with pin receptacles 614, which provides for wireless powering of the electrical components disposed within the picture frame. According to embodiments, pin receptacles 614 comprise magnetic material so as to provide a magnetic force on pins 610, thereby holding pins 610 (and pack 604) in place and maintaining the electrical connection with the picture frame. Like pins 610, receptacles 614 comprise conductive material capable of conducting electricity from pins 610 to electrical components disposed within the picture frame.

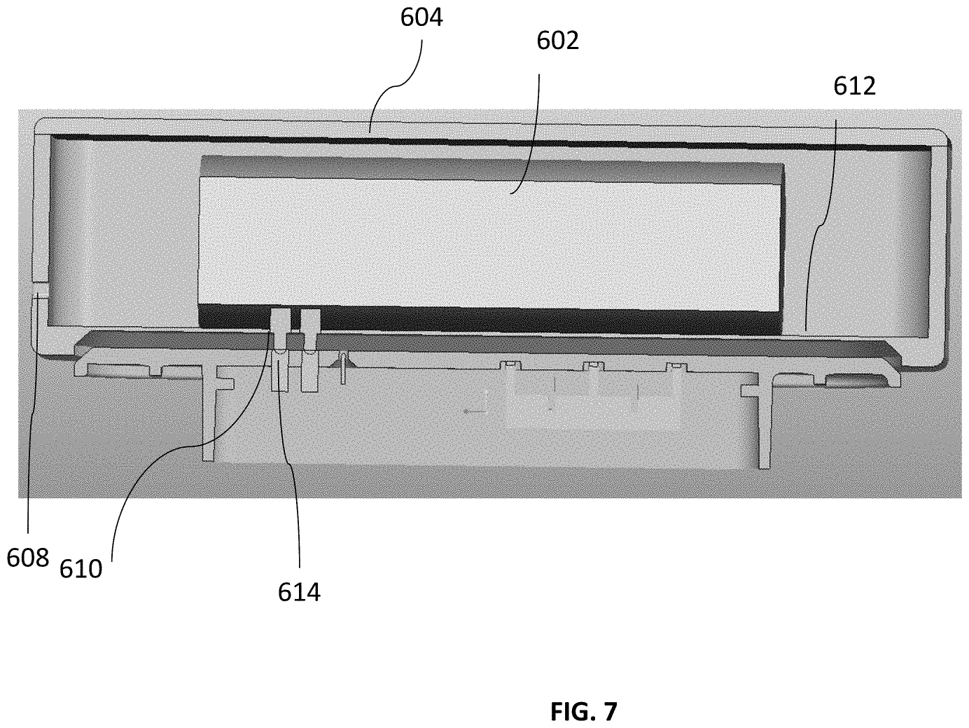

FIG. 7 is a cross-sectional view of components that are used to wirelessly power a picture frame in accordance with exemplary embodiments of the present invention. For the purpose of demonstration, the components depicted in FIG. 7 are labeled the same as they are in FIG. 6, although, it should be understood that many variations of the example depicted are possible and within the scope of the present disclosure.

As shown in FIG. 7, battery pack 604 contains one or more rechargeable batteries 602. The batteries 602 engage with pins 610, which are disposed on the lower surface of pack 604. As shown in the figure, pins 610 engage pin receptacles 614, which are disposed on the surface of control panel 612. Pin receptacles 614, in turn, are connected to internal circuitry that extends from control panel 612 to other components within the picture frame (such as, for example, speakers, amplifiers, lighting elements, and the like). Batteries 602 are recharged via an electrical connection via opening 608, which provides access for an electrical adapter or plug to provide a charging current to batteries 602.

It should also be noted that, in embodiments, instead of charging batteries 602 via a wired plug through opening 608, batteries 602 can be charged via a capacitive charger that is electrically connected to the batteries through pack 604. Further, in exemplary embodiments, a capacitive charger can be used to power the components within the picture frame, such as, for example, the speakers. In such embodiments, instead of attaching a battery pack (like pack 604) to the picture frame via pins 610 and pin receptacles 614, a capacitive charger can be coupled to an adapter on the picture frame to capacitively charge the components disposed within the picture frame. It should be noted that many variations of the exemplary embodiments disclosed herein, such as, for example, the location of the pins 610 and receptacles 614, the shape and size of pack 604, and the use of a rechargeable battery or capacitive charger, are all possible and within the scope of the present invention.

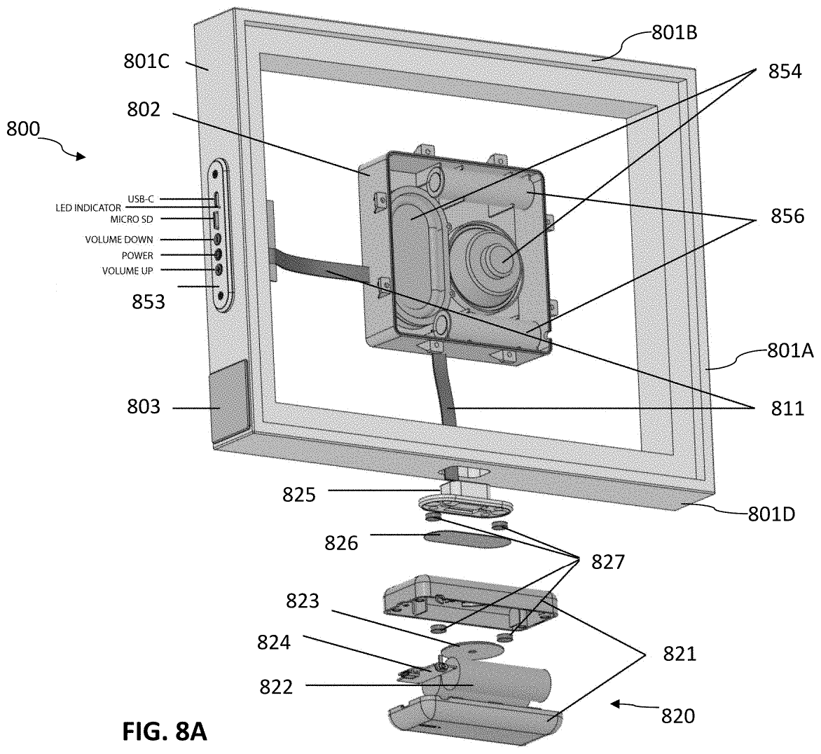

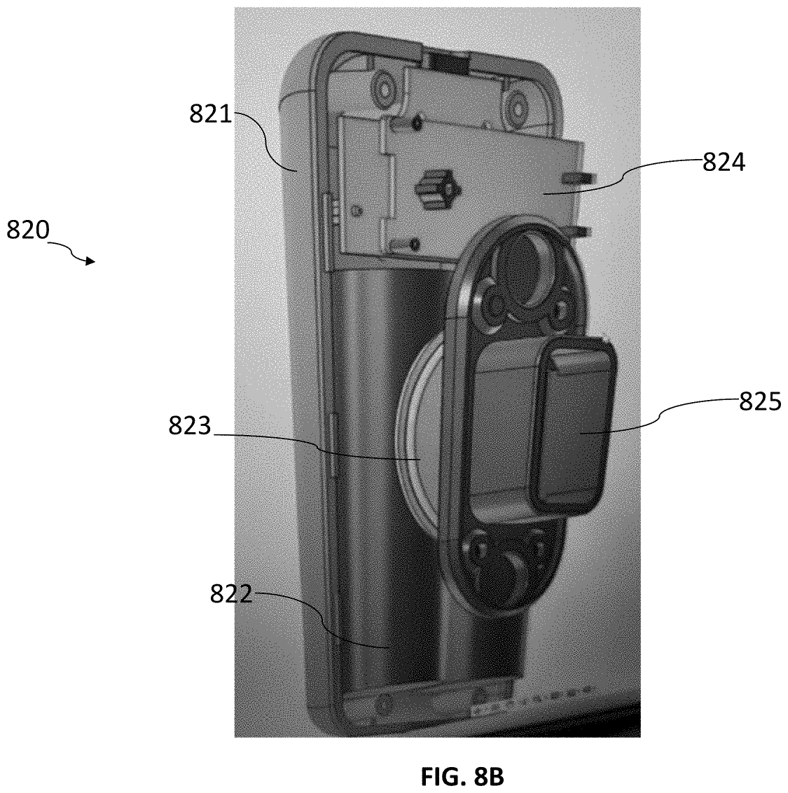

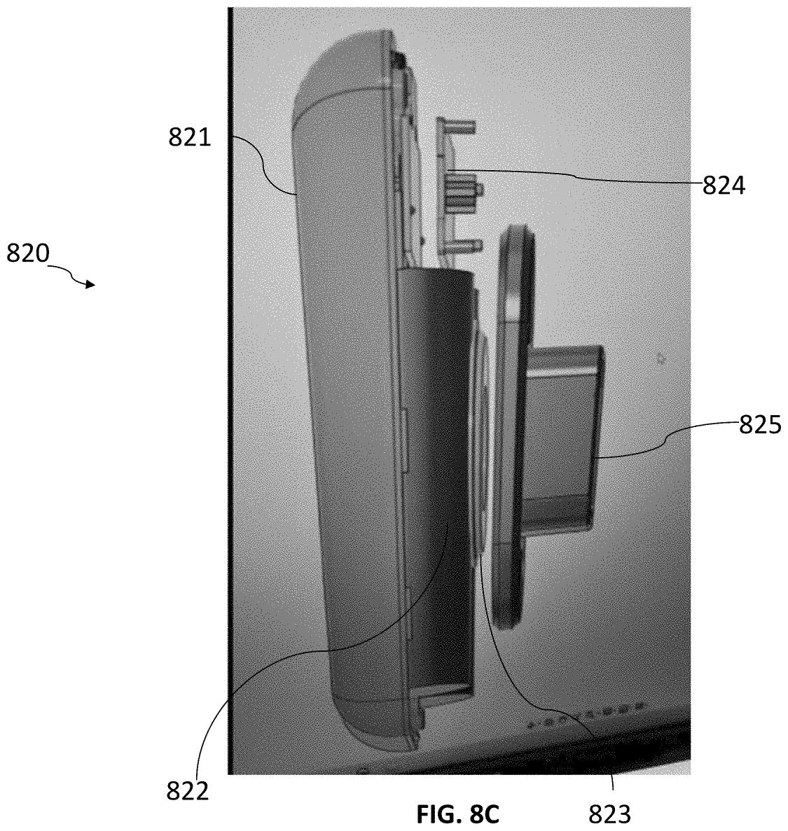

FIG. 8A depicts a perspective view of a picture frame 800 and includes an exploded view of a wireless charger 820, in accordance with exemplary embodiments of the present invention. In embodiments, wireless charger 820 is configured to charge rechargeable batteries within picture frame 800.

As shown in FIG. 8A, picture frame 800 has four frame elements 801A, 801B, 801C, and 801D with frame element 801A corresponding to a first side, frame element 801B corresponding to a second side adjacent to the first side, frame element 801C corresponding to a third side adjacent to the second side, and frame element 801D corresponding to a fourth side adjacent to the third side. The corresponding sides of the four frame elements 801A, 801B, 801C, and 801D provide frame 800 with a generally rectangular or square shape. In exemplary embodiments, frame elements 801A, 801B, 801C, and 801D can be made of wood, metal, steel, plastic, polymer, other rigid material, to name a few.

In exemplary embodiments, picture frame 800 may be configured to be mounted on a wall and/or may be configured to be free-standing, with or without a support stand (not shown). For example, picture frame 800 can be free-standing on the floor, a table, leaned against a wall or solid surface or can be attached to a stand for placing the frame on table or desk, to name a few.

A canvas material (not shown in FIG. 8A) may be mounted within frame 800, with frame elements 801A, 801B, 801C, and 801D surrounding and holding the canvas material in place. As with the other embodiments previously described, the canvas material on which photographs or other artwork are printed or otherwise rendered is often referred to as “chemical canvas.” According to exemplary embodiments, the chemical canvas on which images can be rendered is a 190-gram chemical fiber canvas that is 100 percent polyester, although it should be appreciated that the present invention is not limited to a specific type of chemical canvas.

In exemplary embodiments, frame 800 may have a common picture frame size, such as, for example, 11 inches×14 inches. Various other commonly used dimensions are also possible, such as 8 inches×10 inches and 16 inches×20 inches. In exemplary embodiments, frame elements 801A, 801B, 801C, and 801D may be sized to accommodate one or more speakers of various sizes, such as, for example, 31-millimeter wireless speakers that are currently available for sale. Further, as shown in FIG. 8A, one or more of frame elements 801A-801D can include a logo placard 803 affixed thereto, which aids in product identification. In FIG. 8A, logo placard 803 is affixed to frame element 801C.

As shown in FIG. 8A, control panel 853 is disposed on one of the frame elements (e.g., frame element 801C). According to embodiments, control panel 853 may be disposed on any one of frame element 801A, 801B, and 801D, as well. Control panel 853 includes controls that allow an end user to control powering of and playback by speakers disposed within picture frame 800.

As shown, control panel 853 includes a power button, which provided power directly to the speakers. Control panel 853 also includes volume up and volume down buttons, which control the volume at which the speakers play. Control panel 853 also includes an LED indicator, which indicates whether or not the speakers are receiving power either externally or from a battery. In embodiments, the LED indicator provides an indication of the amount of power the speakers are receiving, which is useful when battery power is being received.

Control panel 853 also includes connection ports which allow power and data transmission from sources external to picture frame 800. For example, as shown in FIG. 8A, control panel 853 includes a USB-C (i.e., USB Type C) connection, which supports powering of the speakers as well as the transmission of data from an external device (such as a laptop computer or tablet computer, to name two) to the internal components of picture frame 800. Similarly, control panel 853 includes a Micro SD (Secure Digital) port, which, in embodiments, allows the transfer of data from an SD flash memory card to electronic components disposed within picture frame 800.

As shown in FIG. 8A, the speaker system of picture frame 800 is disposed in the area bounded by frame elements 801A-801D. In the embodiment depicted, the speaker system is comprised of an electrical enclosure 802, which houses speakers 854 and rechargeable batteries 856. Electrical enclosure 802 provides protection and insulation for the components disposed therein.

Speakers 854 are similar to the speakers in previously described embodiments, such as, for example, audio speaker 154 shown in FIG. 1C and audio speaker 254 shown in FIG. 2E. In the embodiment depicted in FIG. 8A, the speaker system includes two audio speakers 854, which can be, for example, subwoofers, woofers, tweeters, and/or supertweeters, or any combination thereof.

Further, rechargeable batteries 856 are similar to the rechargeable batteries previously described in connection with other embodiments. Rechargeable batteries 856 may be recharged via a power connection through control panel 853, such as, for example, a wire connection through the USB-C port. In embodiments, rechargeable batteries 856 may be recharged through an external wireless charger 820, described further below. Rechargeable batteries 856 receive power over internal power and data cables 811, which are electrically coupled to control panel 853 and wireless charger 820, as the case may be. Rechargeable batteries 856 are connected to speakers 854 via power circuitry (not show) disposed within electrical enclosure 802.

As mentioned, rechargeable batteries 856 may be charged wirelessly via an external wireless charger, such as wireless charger 820 in FIG. 8A. In embodiments, wireless charger 820 includes a protective housing 821, which insulates and protects the batteries and electronic components disposed therein. According to embodiments, protective housing 821 contains rechargeable batteries 822. Rechargeable batteries 822 are similar to rechargeable batteries 856 and provide power wireless to rechargeable batteries 856 in order to power speakers 854.

As shown in FIG. 8A, protective housing 821 also contains wireless charging pad 823, which, in embodiments transmits electrical power wirelessly from rechargeable batteries 822 to one of internal power and data cables 811 which, in turn, transmits electric power to rechargeable batteries 856. In addition, wireless charger 820 itself can be powered on and off. In embodiments, this is performed via a power on button that is exposed through protective housing 821 and connected to printed circuit board (PCB) 824. Further, in situations where rechargeable batteries 822 have been drained, embodiments of wireless charger 820 are equipped with a USB port, similar to the USB-C port on control panel 853, which enables an external powering device to provide power to wireless charger 820. In such cases, the electric power provided through the USB port is used to recharge rechargeable batteries 822.

Wireless charger 820 also includes at least one magnetic attachment 827. According to embodiments, magnetic attachments 827 are used to affix wireless charging pad 823 to an inner wall of protective housing 821 which, on its opposite side, faces one of the frame elements 801 of picture frame 800. As shown in FIG. 8A, magnetic attachments 827 exert a magnetic force and fasten charging pad 823 to the wall of protective housing that faces frame element 801D.

As shown, magnetic attachments 827 are also deployed on the outer part of protective housing 821 which faces frame element 801D. These magnetic attachments exert a magnetic force and fasten protective housing 821 to bracket 825. In embodiments magnetic attachments 827 are deployed on decorative cover 826. In such embodiments, decorative cover 826 is used to conceal wireless charging pad 823 and other components within protective housing 821.

According to embodiments, bracket 825 is pushed through an opening of one of frame elements 801. In FIG. 8A, bracket 825 is mounted to an opening in frame element 801D. As shown, magnetic attachments 827 are deployed between decorative cover 826 and bracket 825, while decorative cover 826 is affixed to an outer wall of protective housing 821. In this way, wireless charger 820 is mounted fixedly to picture frame 800. Power is transmitted wirelessly from rechargeable batteries 822 to power and data cable 811 via wireless charging pad 823. Electric power is then transmitted through power and data cable 811 to electrical enclosure 802. Electrical enclosure 802 includes on its outer surface one or more receptacles that expose connections to circuitry that connects to rechargeable batteries 856. Rechargeable batteries 856 are thereby charged by wireless charger 820.

FIG. 8B depicts an exploded front view of wireless charging device 820, in accordance with exemplary embodiments of the present invention. As shown in FIG. 8B, wireless charging device includes protective housing 821, which provides protection and insulation for the electrical components housed therein. The components depicted in FIG. 8B include rechargeable batteries 822, wireless charging pad 823, and PCB 824. As shown, bracket 825 includes a distal member that is insertable into an opening of a frame member 801, thereby affixing bracket 825 to a side of picture frame 800. Magnetic attachments 827 (as described with respect to FIG. 8A) are used to fasten bracket 825 to an outer wall of protective housing 821.

FIG. 8C depicts an exploded side view of wireless charging device 820, in accordance with exemplary embodiments of the present invention. Similar to the exploded front view of FIG. 8B, FIG. 8C depicts protective housing 821, which encloses rechargeable batteries 822, wireless charging pad 823, and PCB 824. Bracket 825 is fastened to wireless charging device 820 via at least one magnetic attachment 827, as depicted in FIG. 8A.

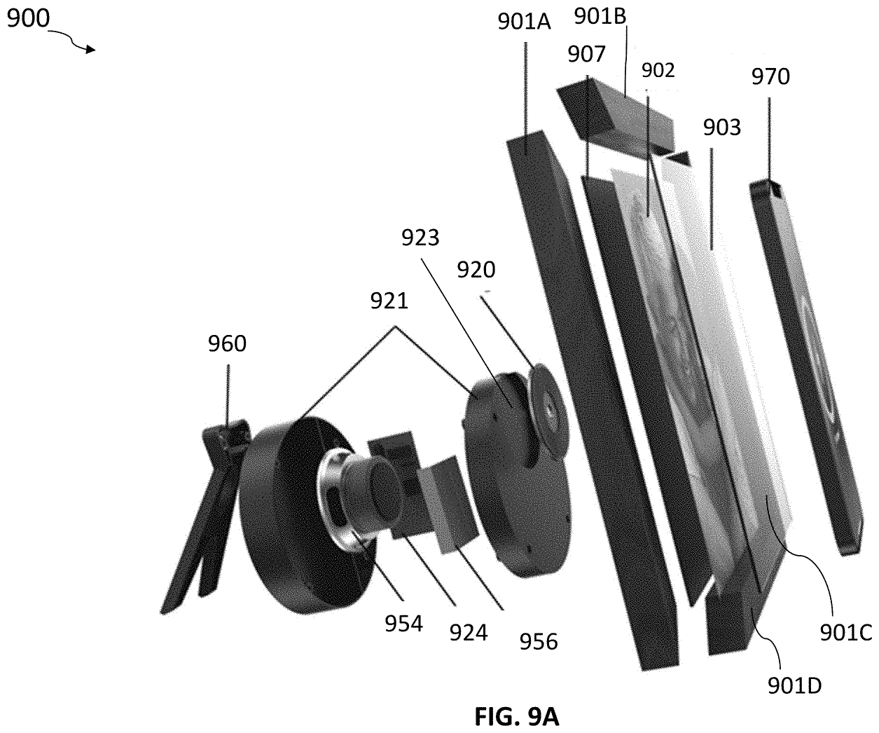

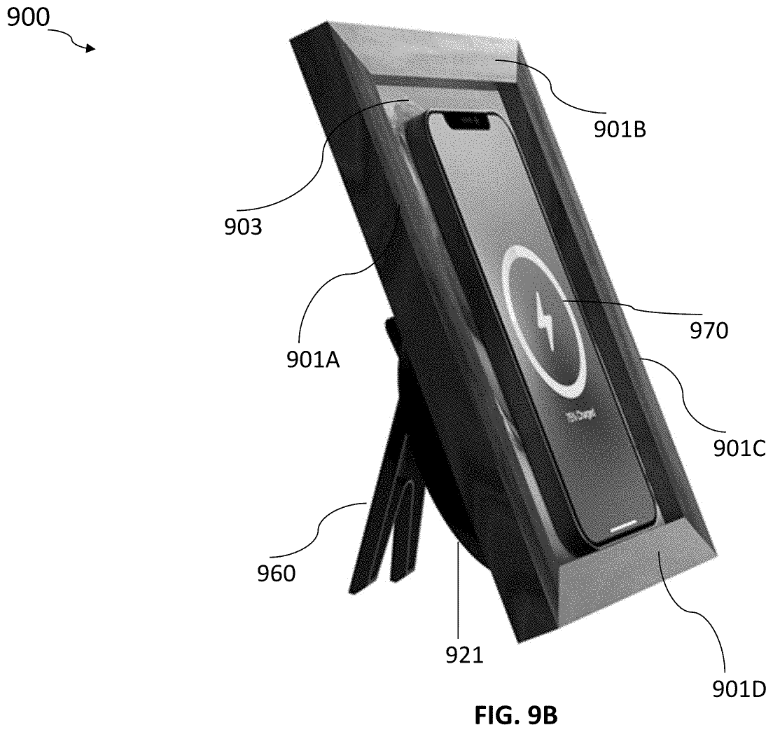

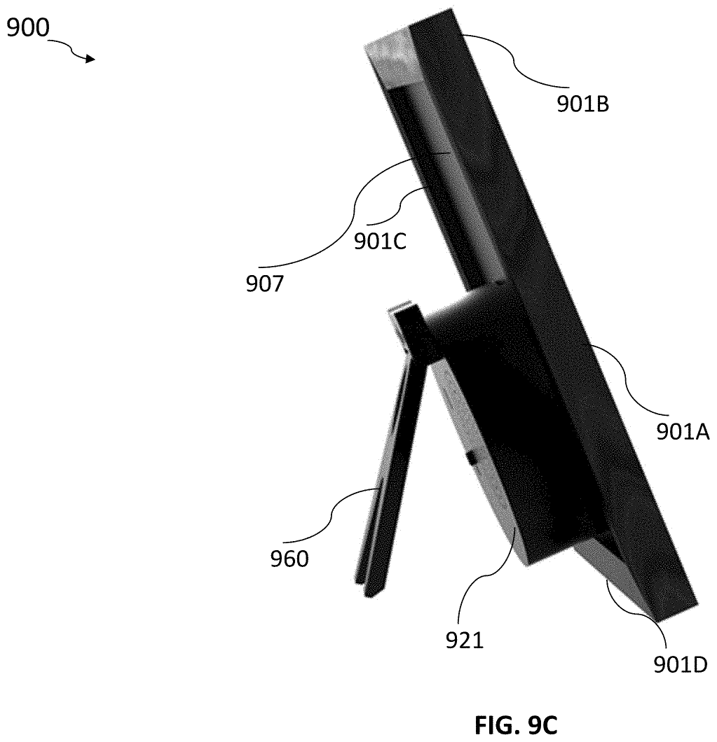

FIGS. 9A-9C illustrate a picture frame, generally designated by reference number 900, for displaying printed photographs, according to another exemplary embodiment of the present invention. As shown in FIG. 9A, picture frame 900 includes four frame elements (designated as 901A, 901B, 901C, and 901D), each of which is attached or fastened to two adjacent frame elements. Thus, in FIG. 9A, frame element 901A is arranged vertically and is attached to frame elements 901B and 901D at each end of frame element 901A; frame element 901B is arrange horizontally and is attached to frame elements 901A and 901C at each end of frame element 901B; frame element 901C is arranged vertically (parallel to frame element 901A) and is attached to frame elements 901B and 901D at each end of frame element 901C; and frame element 901D is arrange horizontally (parallel to frame element 901B) and is attached to frame elements 901C and 901A at each end of frame element 901D.

According to exemplary embodiments, frame elements 901A-901D, when attached to one another, form a rectangular frame that bounds a rectangular area. The picture frame 900 may include a photo backing member 907 that is adapted and sized to fit in this rectangular area, and may be fastened or attached to one or more of frame elements 901A-901D. Photo backing member 907, in exemplary embodiments, can be made of a canvas material on which photographs or other artwork can be rendered. This material can be the chemical canvas described previously in connection with picture frames 100, 200, and 800, for example.

In other exemplary embodiments, photo backing member 907 can be made of a material other than canvas, such as, for example, cardboard, metal, or plastic, to name a few. Photo backing member 907 is configured to conduct soundwaves from the rear of picture frame 900 to the front of picture frame 900. Furthermore, in accordance with exemplary embodiments, photo backing member 907 is configured to allow the passage of electromagnetic radiation for the wireless charging of a device disposed on, or in the vicinity of, the front of picture frame 900, as will be explained in more detail below.

In accordance with the exemplary embodiment depicted in FIG. 9A, a photograph 902 is disposed adjacent to photo backing member 907. In exemplary embodiments, photograph 902 can be a conventional glossy paper photograph whose back side can be glued or otherwise fastened to photo backing member 907. In some exemplary embodiments, photograph 902 can be an artwork or painting rendered on canvas, a piece of paper, or other material upon which artwork is capable of being rendered. Without limitation, photograph 902 can also be an ink, crayon, or charcoal drawing. As with photo backing member 907, photograph 902 allows electromagnetic radiation to pass through in order to charge a wireless device that is disposed on, or in the vicinity of, the front of picture frame 900.

In exemplary embodiments, photograph 902 can be of standard dimensions, such as, for example 5×7 inches. In other exemplary embodiments, photograph 902 can be of other dimensions that fit over, and/or can be fastened to, photo backing member 907. For example, in embodiments, photograph 902 may be 4×6 inches, 8×10 inches, 8.5×11 inches, 12×18 inches, 18×24 inches, or 24×36 inches, to name a few.

In the exemplary embodiment illustrated in FIG. 9A, cover member 903 is disposed on the front of photograph 902. Cover member 903 is transparent and provides protection for the front of photograph 902, allowing photograph 902 to be viewed by an observer. In exemplary embodiments, cover member may be made of any visually transparent material, such as, for example, glass or plastic, and which also allows electromagnetic radiation to pass through in order to charge a wireless device disposed on the front of, or in the vicinity of, frame 900.

As shown in FIG. 9A, frame 900 is adapted, in exemplary embodiments, to stand freely on its own on a flat surface. Thus, behind photo backing member 907 are components that allow the frame 900 to stand upright, as well as to power a speaker disposed therein and to charge a wireless device.

According to exemplary embodiments, frame 900 also includes a wireless charging coil 920. Wireless charging coil 920 is adapted to fit into a recess 923 on a first side of an electronic housing 921 so that at least one surface of the wireless charging coil 920 is exposed, preferably in a direction oriented outwards with respect to the frame 900 so as to be closer in proximity to a wireless device placed against the frame 900. In exemplary embodiments, a battery 956 is disposed within the electronic housing 921 which provides power to the wireless charging coil 920. According to exemplary embodiments, wireless charging coil 920 receives energy from battery 956 and emits electromagnetic radiation (such as, for example RF waves or magnetic resonance charging). The charging radiation passes through photo backing member 907, photograph 902, and glass member 903 to charge a wireless device that is disposed on, or in the vicinity of, frame 900. According to exemplary embodiments, wireless charging coil 920 can be a Qi wireless charger. The wireless device may be, for example, a mobile phone, a tablet, or wireless headphones, to name a few.

Housing 921 is a protective housing that houses electronic components of frame 900. As shown in FIG. 9A, housing 921 contains therein battery 956, printed circuit board (PCB) 924, and speaker 924. As mentioned above, battery 956 can provide power to wireless charging coil 920. The power can be provided via an electrical connection that extends from the battery 956 to the wireless charging coil 920. In exemplary embodiments, the electrical connection extends into the recess 923 in which the wireless charging coil 920 is disposed.

Battery 956 also provides power to PCB 924 and speaker 954. PCB 924 has disposed thereon electronic circuitry that drives speaker 954, and through which an end user can control speaker 954. In exemplary embodiments, PCB 924 is equipped with an antenna that allows near field communication with a wireless device. In such exemplary embodiments, PCB 924 is programmed to receive signals from the wireless device and, in response, control speaker 954. Control of speaker 954 may include powering on and powering off the speaker, as well as raising or lowering the volume at which the speaker plays back audio.

In exemplary embodiments, speaker 954 is a wireless speaker, which can include, for example, subwoofers, woofers, tweeters, and/or supertweeters, or any combination thereof.

According to exemplary embodiments, housing 921 is comprised of an insulating material that is sturdy enough to protect the electronic components disposed therein from damage. Without limitation, housing 921 can be made of plastic, wood, or any non-conductive material that is capable of passing wireless signals (for control of speaker 954) through it.

Also, as shown in FIG. 9A, frame 900 also includes tripod stand 960. According to embodiments, tripod stand 960 is fastened or attached to a rear side of housing 921. As shown, housing 921 and the rest of frame 900 is leaned backward to rest on tripod stand 960. Tripod stand 960 is capable of being placed on a flat surface to hold frame 900 in place. According to exemplary embodiments, and without limitation, tripod stand 960 can be made of materials such as, for example, plastic, metal, wood, or glass, to name a few. Tripod stand 960 can also be collapsible so as to enable convenient storage of frame 900.

According to exemplary embodiments, when tripod stand 960 is deployed on a surface, preferable a substantially flat surface, and supports frame 900, an end user can rest a wireless device, such as smartphone 970 in FIG. 9A, against the front of frame 900. In accordance with exemplary embodiments, smartphone 970 can be rested against cover member 903 and supported from the bottom by frame element 901D. In exemplary embodiments, frame element 901D has a top surface, a portion of which extends outward beyond cover member 903, thus providing a lip on which smartphone 970 can rest. In exemplary embodiments, the top surface of frame element 901D may extend further outward as compared to other surfaces of the frame element 901D and/or as compared to the other frame elements 901A, 901B, 901C so as to provide a protruding lip upon which the device to be charged may be placed.

When smartphone 970 is rested on the front surface of cover member 903, electromagnetic energy emitted by wireless charging coil 920 passes through photo backing member 907, photograph 902, and cover member 903. The electromagnetic energy is received by an antenna or wireless receiver (not shown) integrated within smartphone 970, thus providing electric power for recharging a battery deployed within smartphone 970.

FIG. 9B is a first perspective view of frame 900 in accordance with exemplary embodiments of the present invention. As shown in the figure, smartphone 970 rests against cover member 903 on the front of frame 900. The bottom edge of smartphone 970 also stably rests on the lip formed by the top surface of frame element 901D, whereby the top surface of frame element 901D extends beyond glass member 903. Hidden in this view is wireless charging coil 920, which is disposed in the recess 923 on a front side of housing 921, as described in connection with FIG. 9A above. Thus, in the depicted arrangement, smartphone 970 receives electromagnetic energy from wireless charging coil 920 through the different layers of frame 900 depicted in FIG. 9A, thereby charging a battery (not shown) that is disposed within smartphone 970.

FIG. 9C is a second perspective view of frame 900 in accordance with exemplary embodiments of the present invention. The perspective shown in FIG. 9C depicts how tripod stand 960 connects to a rear side of housing 921. As shown, a front side of housing 921 is connected or fastened to a rear side of photo backing member 907. In addition, the rear side of housing 921 contains at least one hole through which audio can be played from speaker 954, which, as shown and described in connection with FIG. 9A, is disposed within housing 921. In an exemplary embodiment, a series of holes arranged in a pattern, such as, for example, a circular pattern, may be provided in the rear of the housing 921 so that audio played by the speaker 954 can be more easily heard. According to exemplary embodiments, tripod stand 960 is configured to pivot around a horizontal member so as to enable tripod stand 960 to rest flush against the rear side of housing 921, which, as mentioned above, allows for convenient storage of frame 900.

According to exemplary embodiments, a consumer can purchase a speaker-enabled picture frame by interaction (via a web browser or other network enabled application) with a remote ordering system in order to specify the type or style of picture frame they are interested in and the type/quality of speaker they would like. It should be noted that, according to exemplary embodiments, the consumer can interact with the ordering system via a publicly accessible kiosk or sales workstation, which may be situated inside of a retail establishment, and which may itself be proximate to or remote from the ordering system.

According to embodiments, the user can also upload a photograph or artwork image to the ordering system. The ordering system receives the specifications of frame style and speaker type, as well as the image data. Before proceeding, the ordering system may collect identification, address, credit, and payment information from the consumer and verifies this information. Once data and information has been verified, the ordering system generates instructions to select the correct frame materials and speaker, and to assemble these materials into a speaker-enabled picture frame. The ordering system may also generate instructions to print the received image data on to appropriate canvas material (e.g., “chemical canvas”). The ordering system may further generate instructions for mounting the canvas material on to the assembled picture frame to produce a finished picture frame. The ordering system may further generate instructions to package the finished picture frame for mailing to the consumer.

The instructions generated by the system to select and assemble the components of the picture frame can be in a form for transmission to an automated assembly and manufacturing system, such as a 3D printing system, or, alternatively, can be for a human assembler. Similarly, the instructions for printing the image on to the canvas material can be in a form for transmission to an automated printing system or can be for a human to print the material manually. Similarly, the instructions for packaging the finished picture frame can be in a form for transmission to an automated packaging system or, alternatively, to a human for manual packaging. Many variations of these steps are contemplated and within the scope of the present disclosure.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A picture frame comprising:
a plurality of frame elements configured for mounting therein a chemical canvas on which artwork is rendered; and
a speaker system disposed within the plurality of frame elements, the speaker system comprising:
two or more speaker components disposed within the plurality of frame elements, each of the two or more speaker components comprising:
1) a housing;
2) an audio speaker disposed within the housing;
3) a control panel disposed within the housing and configured for manual control of the audio speaker;
4) one or more rechargeable batteries disposed within the housing and configured to power the speaker component and configured to be charged using a wireless magnetic resonance charger or a capacitive charger; and
5) a circuit board disposed within the housing that holds electronic components of the speaker component.

2. The picture frame of claim 1, wherein the electronic components comprise at least one of a receiver, a controller or an amplifier.

3. The picture frame of claim 1, wherein the two or more speaker components are disposed on differing frame elements.

4. The picture frame of claim 1, further comprising:
a wireless communication adapter configured for communication with an external user controller.

5. The picture frame of claim 1, wherein the one or more rechargeable batteries are configured to be charged using an external charging plug.

6. The picture frame of claim 1, wherein the one or more rechargeable batteries are disposed within a removeable battery pack.

7. The picture frame of claim 1, further comprising an external battery pack configured to recharge the one or more rechargeable batteries.

8. The picture frame of claim 7, wherein:
the external battery pack comprises one or more conductive pins; and
at least one of the two or more speaker components comprises one or more pin receptacles configured for engagement with the one or more conductive pins to transmit electrical energy to the one or more batteries within the at least one of the two or more speaker components.

9. The picture frame of claim 1, wherein the speaker components are configured for control by a dedicated application program installed on a mobile phone.

10. A picture frame comprising:
a plurality of frame elements configured for mounting thereon a chemical canvas on which artwork is rendered; and
a speaker system disposed within the plurality of frame elements, the speaker system comprising:
a speaker component disposed between the plurality of frame elements, the speaker component comprising:
1) a housing;
2) an audio speaker disposed within the housing and exposed at a front portion of the picture frame so as to play audio through the chemical canvas;
3) a control panel disposed within the housing and configured for manual control of the audio speaker, the control panel being exposed at a back portion of the picture frame;
4) one or more rechargeable batteries disposed within the housing and configured to power the speaker component and configured to be charged using a wireless magnetic resonance charger or a capacitive charger; and
5) a circuit board disposed within the housing that holds electronic components of the speaker component.

11. The picture frame of claim 10, wherein the electronic components comprise at least one of a receiver, a controller or an amplifier.

12. The picture frame of claim 10, further comprising:
a wireless communication adapter configured for communication with an external user controller.

13. The picture frame of claim 10, wherein the one or more rechargeable batteries are configured to be charged through a charging plug disposed in one of the plurality of frame elements.

14. The picture frame of claim 10, further comprising an external battery pack configured to recharge the one or more rechargeable batteries.

15. The picture frame of claim 14, wherein:
the external battery pack comprises one or more conductive pins; and
the speaker component comprises one or more pin receptacles configured for engagement with the one or more conductive pins to transmit electrical energy to the one or more batteries within the speaker component.

16. The picture frame of claim 1, wherein the speaker component is configured for control by a dedicated application program installed on a mobile phone.

17. A picture frame comprising:
a plurality of frame elements;
a chemical canvas on which artwork is rendered and which is mounted directly on the plurality of frame elements; and
a speaker system disposed within the plurality of frame elements, the speaker system comprising:
a speaker component, the speaker component comprising:
1) an audio speaker disposed between the plurality of frame elements or within a first one of the plurality of frame elements;
2) a control panel disposed within the first one of the plurality of frame elements or a second one of the plurality of frame elements that is different from the first one of the plurality of frame elements and configured for manual control of the audio speaker;
3) a battery compartment that houses one or more rechargeable batteries, the battery compartment disposed within the first one of the plurality of frame elements, the second one of the plurality of frame elements or a third one of the plurality of frame elements that is different from the first one of the plurality of frame elements and the second one of the plurality of frame elements, the one or more rechargeable batteries configured to power the speaker component and configured to be charged using a wireless magnetic resonance charger or a capacitive charger; and
4) a circuit board that holds electronic components of the speaker component,
the control panel and the battery compartment being exposed through an opening in the chemical canvas.

18. The picture frame of claim 17, wherein the electronic components comprise at least one of a receiver, a controller or an amplifier.

19. The picture frame of claim 17, further comprising:
a wireless communication adapter configured for communication with an external user controller.

20. The picture frame of claim 17, further comprising an external battery pack configured to recharge the one or more rechargeable batteries.

21. The picture frame of claim 20, wherein:
the external battery pack comprises one or more conductive pins; and
the speaker component comprises one or more pin receptacles configured for engagement with the one or more conductive pins to transmit electrical energy to the one or more batteries within the speaker component.

22. The picture frame of claim 17, wherein the speaker component is configured for control by a dedicated application program installed on a mobile phone.

23. A picture frame comprising:
(A) a plurality of frame elements;
(B) a cover member disposed within the plurality of frame elements;
(C) a backing member disposed behind the cover member so that the cover member and the backing member are configured to hold a photograph or other artwork therebetween and within the plurality of frame elements;
(D) an electrical housing affixed to the plurality of frame elements, the electrical housing configured to house at least the following components:
(i) a battery;
(ii) one or more speakers;
(iii) a printed circuit board; and
(iv) a wireless charging coil configured to provide wireless charging to a wireless device placed in contact with or immediately adjacent to the cover member through the backing member and the cover member; and
(E) a stand affixed to a rear side of the electrical housing.

24. The picture frame of claim 23, wherein the wireless charging coil is disposed on a front side of the electrical housing.

25. The picture frame of claim 24, wherein the front side of the electrical housing is disposed adjacent to and in contact with the backing member.

26. The picture frame of claim 23, wherein a lip is formed between an edge of one of the plurality of frame elements and the cover member, the lip configured to hold in place a wireless device when the picture frame is in an upright position.
